(19) United States
(12) Patent Application Publication
(10) Pub. No.: US 2021/0368170 A1
(43) Pub. Date: Nov. 25, 2021

(54) HIGH LEVEL CONTROL OF PDPC AND INTRA REFERENCE SAMPLE FILTERING OF VIDEO CODING

(71) Applicant: ALIBABA GROUP HOLDING LIMITED, George Town (KY)

(72) Inventors: Mohammed Golam SARWER, Cupertino, CA (US); Yan YE, San Diego, CA (US)

(21) Appl. No.: 17/327,346

(22) Filed: May 21, 2021

Related U.S. Application Data
(60) Provisional application No. 63/027,982, filed on May 21, 2020.

(51) Int. Cl. H04N 19/117; H04N 19/105; H04N 19/196; H04N 19/159; H04N 19/184

(52) U.S. Cl. CPC H04N 19/117; H04N 19/105; H04N 19/184; H04N 19/159; H04N 19/196

(57) ABSTRACT

The present disclosure provides systems and methods for video decoding. The method can include: receiving a video bitstream; determining whether a first flag associated with the bitstream satisfies a given condition; and in response to the determination that the first flag satisfies the given condition, disabling the process for the bitstream, wherein the decoding process comprises at least one of position dependent intra prediction combination (PDPC) and intra reference filtering.

### CROSS-REFERENCE TO RELATED APPLICATIONS

The disclosure claims the benefits of priority to U.S. Provisional Application No. 63/027,982 filed on May 21, 2020, which is incorporated herein by reference in its entirety.

### TECHNICAL FIELD

The present disclosure generally relates to video processing, and more particularly, to methods and apparatuses for processing video content with a high level control of position dependent intra prediction combination (PDPC) and intra reference filtering.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for video decoding. In some exemplary embodiments, the method includes: receiving a video bitstream; determining whether a first flag associated with the bitstream satisfies a given condition; and in response to the determination that the first flag satisfies the given condition, disabling a decoding process for the bitstream, wherein the decoding process comprises at least one of position dependent intra prediction combination (PDPC) and intra reference filtering.

Embodiments of the present disclosure provide a system for video decoding. The system comprises: a memory storing a set of instructions; and a processor configured to execute the set of instructions to cause the system to perform: receiving a video bitstream; determining whether a first flag associated with the bitstream satisfies a given condition; and in response to the determination that the first flag satisfies the given condition, disabling a decoding process for the bitstream, wherein the decoding process comprises at least one of position dependent intra prediction combination (PDPC) and intra reference filtering.

Embodiments of the present disclosure further provide a non-transitory computer readable medium that stores a set of instructions that is executable by one or more processors of an apparatus to cause the apparatus to initiate a method for video decoding. The method comprises: a memory storing a set of instructions; and a processor configured to execute the set of instructions to cause the system to perform: receiving a video bitstream; determining whether the first flag associated with the bitstream satisfies a given condition; and in response to the determination that the first flag satisfies the given condition, disabling a decoding process for the bitstream, wherein the decoding process comprises at least one of position dependent intra prediction combination (PDPC) and intra reference filtering.

Embodiments of the present disclosure provide a method for video encoding. In some exemplary embodiments, the method includes: determining whether a video bitstream satisfies a given condition; and in response to a determination that the bitstream satisfies the given condition, signaling in the bitstream, a first flag indicating whether a coding process is disabled, wherein the coding process comprises at least one of position dependent intra prediction combination (PDPC) and intra reference filtering.

Embodiments of the present disclosure provide a system for video encoding. The system comprises: a memory storing a set of instructions; and a processor configured to execute the set of instructions to cause the system to perform: determining whether a video bitstream satisfies a given condition; and in response to the determination that the bitstream satisfies the given condition, signaling in the bitstream, a first flag indicating whether a coding process is disabled, wherein the coding process comprises at least one of position dependent intra prediction combination (PDPC) and intra reference filtering.

Embodiments of the present disclosure further provide a non-transitory computer readable medium that stores a set of instructions that is executable by one or more processors of an apparatus to cause the apparatus to initiate a method for video encoding. The method comprises: a memory storing a set of instructions; and a processor configured to execute the set of instructions to cause the system to perform: determining whether a video bitstream satisfies a given condition; and in response to the determination that the first flag satisfies the given condition, signaling in the bitstream, a first flag indicating whether a coding process is disabled, wherein the coding process comprises at least one of position dependent intra prediction combination (PDPC) and intra reference filtering.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, consistent with some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, consistent with some embodiments of the present disclosure.

FIG. 5 illustrates exemplary intra prediction directions, consistent with some embodiments of the disclosure.

FIG. 6 illustrates exemplary definition of reference samples (R_{x,-1}, R_{-1,y} and R_{-1,-1}) for PDPC applied over various prediction modes, consistent with some embodiments of the disclosure.

FIG. 7 illustrates an exemplary coding syntax table of a sequence parameter set (SPS), consistent with some embodiments of the present disclosure.

FIG. 8 illustrates an exemplary coding syntax table of a picture parameter set (PPS), consistent with some embodiments of the present disclosure.

FIG. 9 illustrates an exemplary coding syntax table of a picture header (PH), consistent with some embodiments of the present disclosure.

FIG. 10 illustrates an exemplary coding syntax table of a slice header (SH), consistent with some embodiments of the present disclosure.

FIG. 11 illustrates an exemplary coding syntax table 1100 of the combination of the SPS flag and a block differential pulse coded modulation (BDPCM), consistent with some embodiments of the present disclosure.

FIG. 12 illustrates an exemplary coding syntax table of SPS for 4:4:4 video content, consistent with some embodiments of the present disclosure.

FIG. 13 illustrates an exemplary coding syntax table directed to a PDPC constraint flag, consistent with some embodiments of the present disclosure.

FIG. 14 illustrates an exemplary coding syntax table directed to a PDPC level control using inverse semantics, consistent with some embodiments of the present disclosure.

FIG. 15 illustrates an exemplary coding syntax table directed to a SPS level control of intra reference filter, consistent with some embodiments of the present disclosure.

FIG. 16 illustrates an exemplary coding syntax table directed to a PPS level control of intra reference filter, consistent with some embodiments of the present disclosure.

FIG. 17 illustrates an exemplary coding syntax table directed to a PH level control of intra reference filter, consistent with some embodiments of the present disclosure.

FIG. 18 illustrates an exemplary coding syntax table directed to SH level control of intra reference filter, consistent with some embodiments of the present disclosure.

FIG. 19 illustrates an exemplary coding syntax directed to a SPS level control of intra reference filtering when the BDPCM is disabled, consistent with some embodiments of the present disclosure.

FIG. 20 illustrates an exemplary coding syntax table directed to a SPS level control of intra reference sample filtering for 4:4:4 video content, consistent with some embodiments of the present disclosure.

FIG. 21 illustrates an exemplary coding syntax table directed to a constraint flag of intra reference sample filtering, consistent with some embodiments of the present disclosure.

FIG. 22 illustrates an exemplary coding syntax table directed to the SPS level control of intra reference sample filtering using inverse semantics, consistent with some embodiments of the present disclosure.

FIG. 23 illustrates an exemplary coding syntax table directed to a single SPS flag to control both PDPC and intra reference filter, consistent with some embodiments of the present disclosure.

FIG. 24 illustrates an exemplary coding syntax table directed to a single SPS flag to control both PDPC and intra reference filter using inverse semantics, consistent with some embodiments of the present disclosure.

FIG. 25 illustrates an exemplary flow diagram for a high level control of PDPC and intra reference filtering, consistent with some embodiments of the present disclosure.

FIG. 26 illustrates an exemplary flow diagram for a first flag satisfies a given condition, consistent with some embodiments of the present disclosure.

FIG. 27 illustrates an exemplary flow diagram for a first flag is not signaled in a bitstream, consistent with some embodiments of the present disclosure.

FIG. 28 illustrates an exemplary flow diagram for a high level control of PDPC and intra reference filtering when the BDPCM is disabled, consistent with some embodiments of the present disclosure.

FIG. 29 illustrates an exemplary flow diagram for a high level control of PDPC and intra reference filtering for several video formats, consistent with some embodiments of the present disclosure.

FIG. 30 illustrates an exemplary flow diagram for a third flag signaled in the bitstream, consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

In order to achieve the same subjective quality as HEVC/H.265 using half the bandwidth, the Joint Video Experts Team (“JVET”) has been developing technologies beyond HEVC using the joint exploration model (“JEM”) reference software. As coding technologies were incorporated into the JEM, the JEM achieved substantially higher coding performance than HEVC. The VCEG and MPEG have also formally started the development of a next generation video compression standard beyond HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or frames) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

To reduce the storage space and the transmission bandwidth needed by such applications, the video can be compressed. For example, the video can be compressed before storage and transmission and decompressed before the display. The compression and decompression can be implemented by software executed by a processor (e.g., a processor of a generic computer) or specialized hardware. The module or circuitry for compression is generally referred to as an “encoder,” and the module or circuitry for decompression is generally referred to as a “decoder.” The encoder and the decoder can be collectively referred to as a “codec.” The encoder and the decoder can be implemented as any of a variety of suitable hardware, software, or a combination thereof. For example, the hardware implementation of the encoder and the decoder can include circuitry, such as one or more microprocessors, digital signal processors (“DSPs”), application-specific integrated circuits (“ASICs”), field-programmable gate arrays (“FPGAs”), discrete logic, or any combinations thereof. The software implementation of the encoder and the decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture. If information that was disregarded in the video encoding process cannot be fully reconstructed, the encoding process can be referred to as “lossy.” Otherwise, it can be referred to as “lossless.” Most encoding processes are lossy, which is a tradeoff to reduce the needed storage space and the transmission bandwidth.

In many cases, the useful information of a picture being encoded (referred to as a “current picture”) can include changes with respect to a reference picture (e.g., a picture previously encoded or reconstructed). Such changes can include position changes, luminosity changes, or color changes of the pixels. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

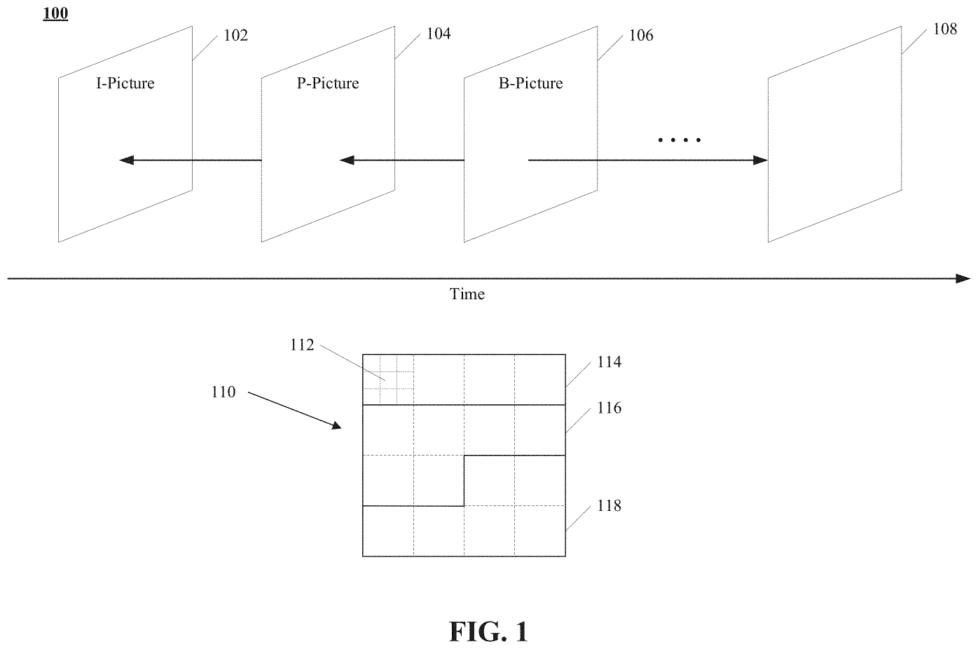

FIG. 1 shows structures of an example video sequence, according to some embodiments of the present disclosure. As shown in FIG. 1, video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

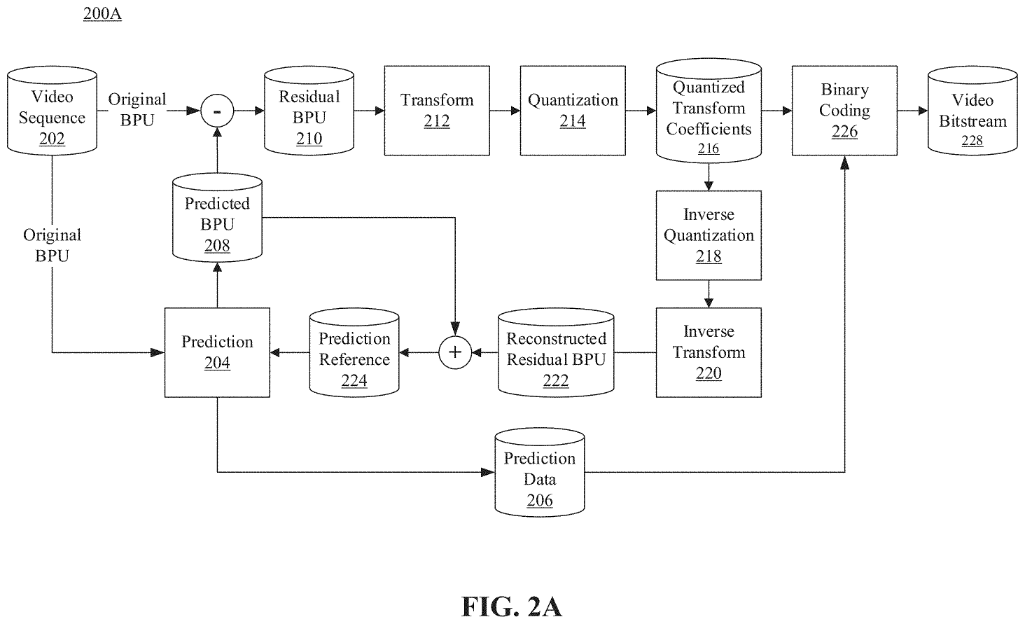

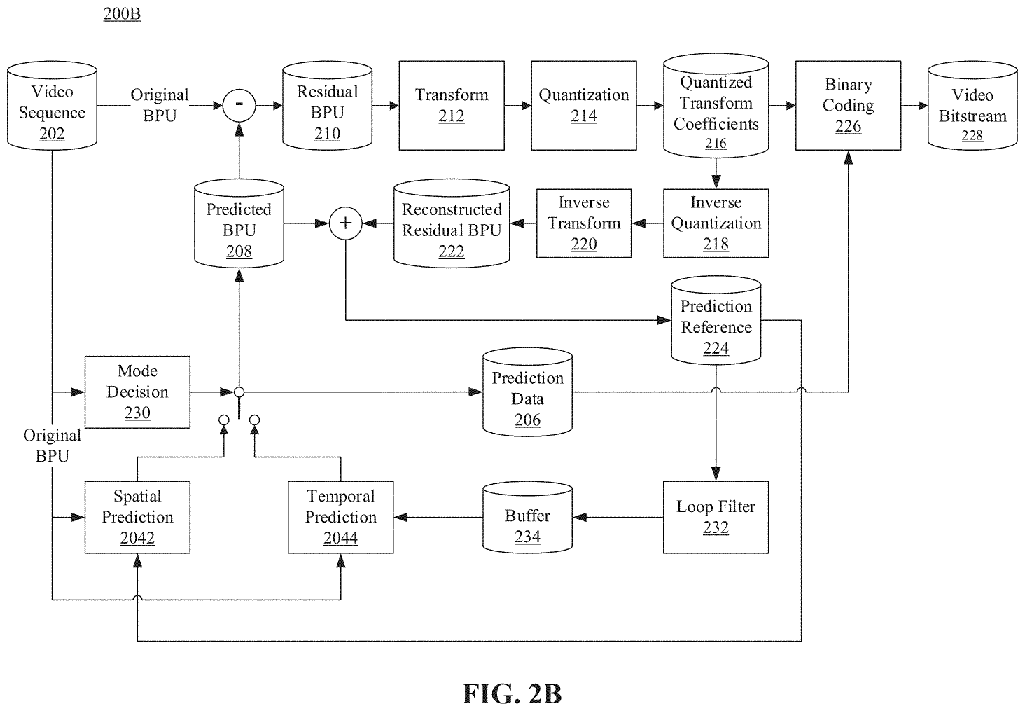

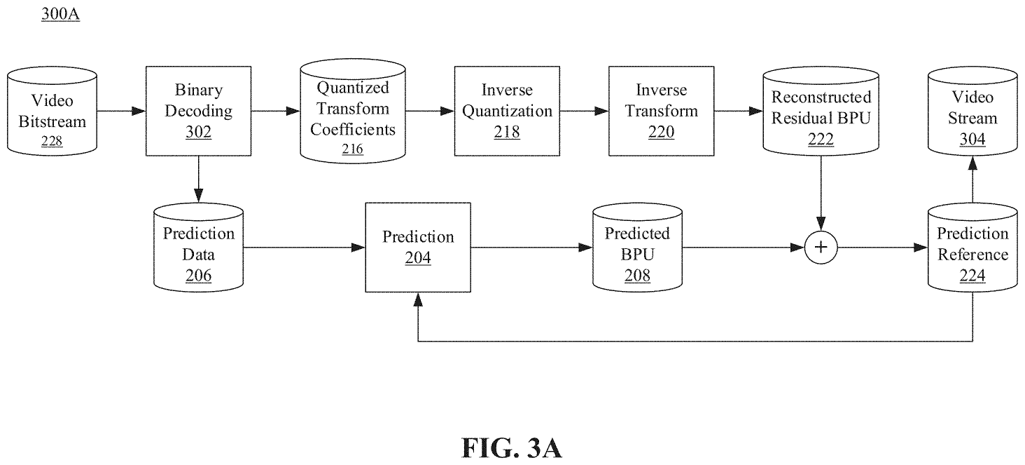

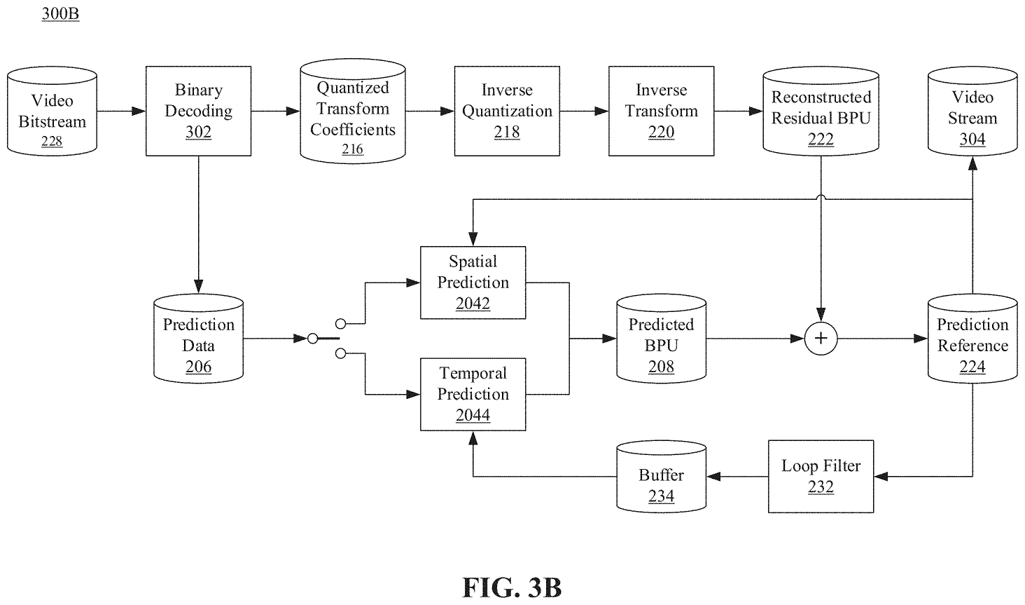

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/IEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/IEVC or H.266/VVC), at the level of which the transform operation can be performed. It should be noted that the division schemes of the same basic processing sub-unit can be different at the prediction stage and the transform stage. For example, in H.265/IEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/IEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A shows a schematic of an example encoding process, according to some embodiments of the present disclosure. For example, encoding process 200A shown in FIG. 2A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B shows a schematic of another example encoding process, according to some embodiments of the present disclosure. As shown in FIG. 2B, process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (i.e., pictures 104 and 108) are at both temporal directions with respect to picture 104.

Still referring to the forward path of process 200B, after spatial prediction stage 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A shows a schematic of an example decoding process, according to some embodiments of the present disclosure. As shown in FIG. 3A, process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B shows a schematic of another example decoding process, according to some embodiments of the present disclosure. As shown in FIG. 3B, process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

There can be four types of loop filters. For example, the loop filters can include a deblocking filter, a sample adaptive offsets (“SAO”) filter, a luma mapping with chroma scaling (“LMCS”) filter, and an adaptive loop filter (“ALF”). The order of applying the four types of loop filters can be the LMCS filter, the deblocking filter, the SAO filter, and the ALF. The LMCS filter can include two main components. The first component can be an in-loop mapping of the luma component based on adaptive piecewise linear models. The second component can be for the chroma components, and luma-dependent chroma residual scaling can be applied.

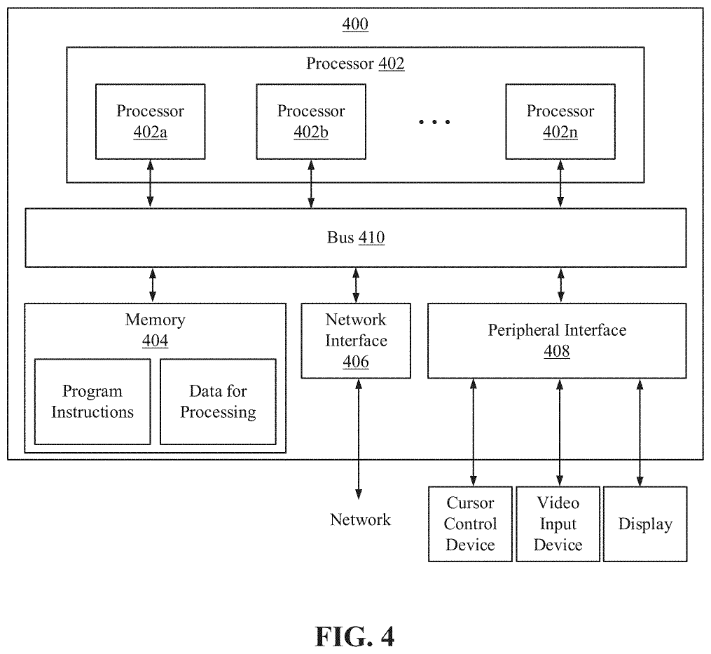

FIG. 4 shows a block diagram of an example apparatus for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface communicatively coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

In the quantization and inverse quantization functional blocks (e.g., quantization 214 and inverse quantization 218 of FIG. 2A or FIG. 2B, inverse quantization 218 of FIG. 3A or FIG. 3B), a quantization parameter (QP) is used to determine the amount of quantization (and inverse quantization) applied to the prediction residuals. Initial QP values used for coding of a picture or slice can be signaled at the high level, for example, using init_qp_minus26 syntax element in the Picture Parameter Set (PPS) and using slice_qp_delta syntax element in the slice header. Further, the QP values can be adapted at the local level for each CU using delta QP values sent at the granularity of quantization groups.

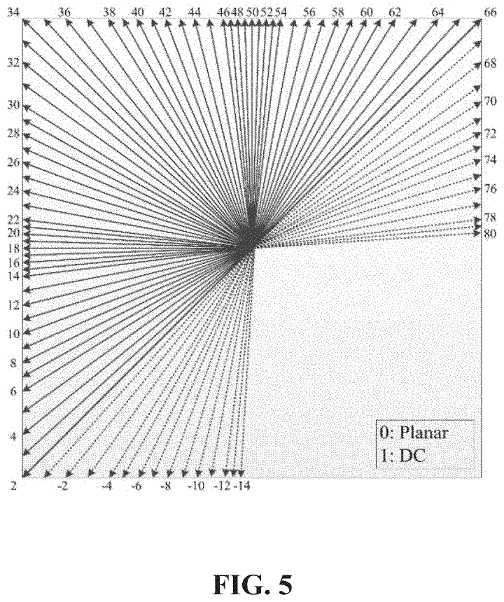

FIG. 5 illustrates some intra prediction directions that are supported VVC (e.g., VVC draft 9). In other words, in order to capture the arbitrary edge directions presented in natural video, a number of directional intra modes are introduced in VVC (e.g., VVC draft 9).

In some embodiments, a predicted block is generated from the top and left reference samples in the intra prediction method. In certain prediction modes, the neighboring reference samples are filtered. In VVC (e.g., VVC draft 9), the reference sample filtering is applied to following intra prediction modes under certain conditions as below. If predModeIntra is equal to 0, −14, −12, −10, −6, 2, 34, 66, 72, 76, 78, or 80, refFilterFlag is set equal to 1. Otherwise, refFilterFlag is set equal to 0.

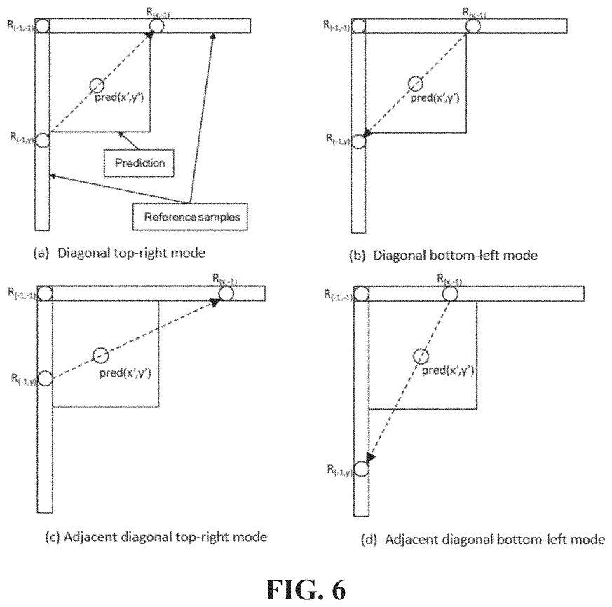

FIG. 6 illustrates the definition of reference samples (R_{x,-1}, R_{-1,y} and R_{-1,-1}) for PDPC applied over various prediction modes. In addition to reference sample filtering process, in VVC, the results of intra prediction of DC, planar and several angular modes are further modified by a position dependent intra prediction combination (PDPC) method. The prediction sample pred(x,y) is predicted using an intra prediction mode (e.g., DC, planar, angular) and a linear combination of reference samples according to the following equation.

pred(x,y)=(wL×R_{-1,y}+wT×R_{x,-1}−wTL×R_{-1,-1}+(64−wL−wT+wTL)×pred(x,y)+32)>>6

Where R_{x,-1}, R_{-1,y} represent the reference samples located at the top and left boundaries of current sample (x, y), respectively, and R_{-1,-1} represents the reference sample located at the top-left corner of the current block. The detailed description can be found in “Algorithm description for Versatile Video Coding and Test Model 8 (VTM 8)”, JVET-Q2002, January 2020, which is incorporated in the present disclosure by reference.

The current design of intra-prediction of VVC Interaction with screen content sequences include the intra reference sample filtering process and PDPC are efficient for natural camera capture content where the correlation between the neighboring regions in an image is very high. In the case of screen content sequences being rich in high frequency information, such as text and graphics content, it is observed that PDPC produces some visual artifacts due to over smoothing of the predicted blocks.

In VVC, there is no high-level flag to perform high level control the PDPC and reference sample filtering. That means, if a user wants to disable PDPC and reference filtering process for some type of content (such as text, graphics, computer screen where filtering and PDPC do not help), the current VVC specification does not allow it. To reduce the visual artifacts, embodiments of the disclosure provide a high level control of PDPC.

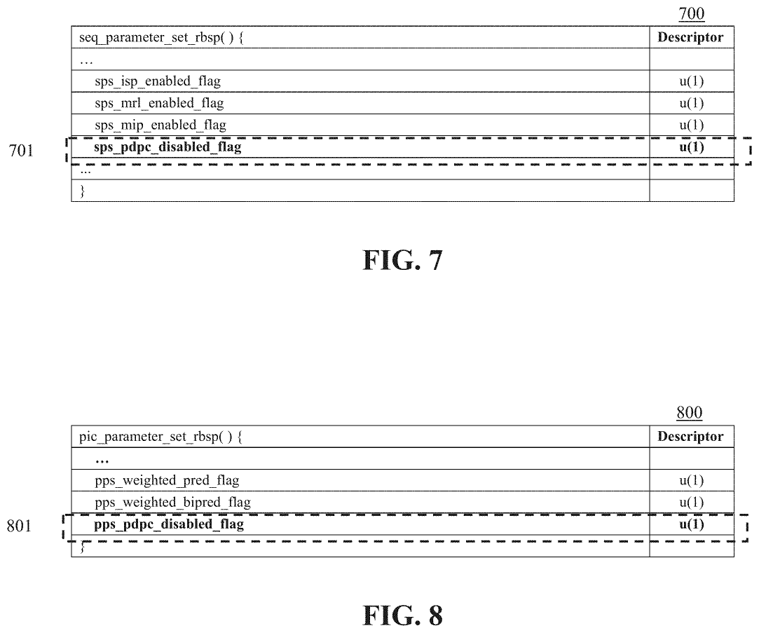

FIG. 7 illustrates an exemplary coding syntax table of a sequence parameter set (SPS) 700. In some embodiments, an SPS flag is introduced to control the PDPC process and directed to a SPS level control of PDPC. FIG. 7 shows semantics of an example for the proposed SPS flag. The following Table 1 shows the semantics of the proposed PPS flag, consistent with the disclosed embodiments.

TABLE 1
Semantics of proposed SPS flag for controlling PDPC process

sps_{—}pdpc_{—}disabled_{—}flag equal to 1 specifies that the position-dependent
intra prediction process is disabled for the coded layer video sequence
(CLVS).
sps_pdpc_disabled_flag equal to 0 specifies that the position-dependent
intra prediction process can be enabled for the CLVS.

As shown in FIG. 7, changes from the VVC proposed by the method being emphasis shown in bold. In some embodiments, parameter 701 (e.g., sps_pdpc_disabled_flag) equal to 1 specifies that the PDPC is disabled for the coded layer video sequence (CLVS). For example, parameter 701 (sps_pdpc_disabled_flag) equal to 0 specifies that the position-dependent intra prediction process can be enabled for the CLVS. When parameter 701 is not present, parameter 701 (sps_pdpc_disabled_flag) is inferred to be 0.

Table 2 below shows the changes made by the above proposed method to the exiting decoding process of intra prediction (e.g., paragraph “8.4.5.2.5: General intra sample prediction” of VVC draft 9). Specifically, in Table 2, the proposed changes to the VVC draft 9 are italicized and shown in bold.

TABLE 2
Proposed changes to paragraph 8.4.5.2.5: General intra sample prediction” of VVC draft 9

When all of the following conditions are true, the position-dependentprediction sample filtering process
specified in clause 8.4.5.2.14 is invoked with the intra prediction modepredModeIntra, the transform
block width nTbW, the transform block height nTbH, the predicted samplespredSamples[ x ][ y ], with
x = 0..nTbW − 1, y = 0..nTbH − 1, the referencesample width refW, the reference sample height refH,
and the reference samples p[ x ][ y ], with x =−1, y = −1..refH − 1 and x = 0..refW − 1, y = −1 as inputs,
and the output is the modified predicted sample array predSamples:

| | |
|---|---|
| - | [symbol] |
| - | nTbW is greater than or equal to 4 and nTbH is greater than or equal to 4 |
| - | refIdx is equal to 0 or cIdx is not equal to 0 |
| - | BdpcmFlag[ xTbCmp ][ yTbCmp ][ cIdx ] is equal to 0 |
| - | One of the following conditions is true: |

| | |
|---|---|
| - | predModeIntra is equal to INTRA_PLANAR |
| - | predModeIntra is equal to INTRA_DC |
| - | predModeIntra is less than or equal to INTRA_ANGULAR18 |
| - | predModeIntra is greater than or equal to INTRA_ANGULAR50 and less than |
| | INTRA_LT_CCLM. |

FIG. 8 illustrates an exemplary coding syntax table of a picture parameter set (PPS) 800. In some embodiments, a PPS flag is introduced to control the PDPC process and directed to a PPS level control of PDPC. FIG. 8 shows the syntax table of an example for the proposed PPS flag. The following Table 3 shows the semantics of the proposed PPS flag, consistent with the disclosed embodiments.

TABLE 3
Semantics of proposed PPS flag for controlling PDPC process

pps_{—}pdpc_{—}disabled_{—}flag equal to 1 specifies that the position-dependent
intra prediction process is disabled for all intra blocks referring to the PPS.
pps_pdpc_disabled_flag equal to 0 specifies that the position-dependent
intra prediction process may be enabled for the intra predicted blocks
referring to the PPS.

As shown in FIG. 8, parameter 801 (e.g., pps_pdpc_disabled_flag) equal to 1 specifies that the position-dependent intra prediction process is disabled for all intra blocks referring to the PPS. For example, pps_pdpc_disabled_flag can be equal to 0 specifies that the position-dependent intra prediction process may be enabled for the intra predicted blocks referring to the PPS. When parameter 801 is not present, pps_pdpc_disabled_flag can be inferred to 0.

Table 4 below shows the changes of the decoding process of intra prediction (paragraph “8.4.5.2.5: General intra sample prediction” of VVC draft 9) of the above method as compared to VVC draft 9. Specifically, in Table 4, the proposed changes to the VVC draft 9 are italicized and shown in bold.

TABLE 4
Proposed changes to paragraph 8.4.5.2.5: General intra sample prediction” of VVC draft 9

When all of the following conditions are true, the position-dependent prediction sample filtering process
specified in clause 8.4.5.2.14 of VVC draft 9 is invoked with the intra prediction mode predModeIntra, the
transform block width nTbW, the transform block height nTbH, the predicted samples predSamples[ x ][ y ],
with x = 0...nTbW − 1, y = 0...nTbH − 1, the reference sample width refW, the reference sample height refH,
and the reference samples p[ x ][ y ], with x = −1, y = −1...refH − 1 and x = 0...refW − 1, y = −1 as inputs,
and the output is the modified predicted sample array predSamples.

| | |
|---|---|
| - | [symbol] |
| - | nTbW is greater than or equal to 4 and nTbH is greater than or equal to 4 |
| - | refIdx is equal to 0 or cIdx is not equal to 0 |
| - | BdpcmFlag[ xTbCmp ][ yTbCmp ][ cIdx ] is equal to 0 |
| - | One of the following conditions is true: |
| | - predModeIntra is equal to INTRA_PLANAR |
| | - predModeIntra is equal to INTRA_DC |
| | - predModeIntra is less than or equal to INTRA_ANGULAR18 |
| | - predModeIntra is greater than or equal to INTRA_ANGULAR50 and less than INTRA_LT_CCLM |

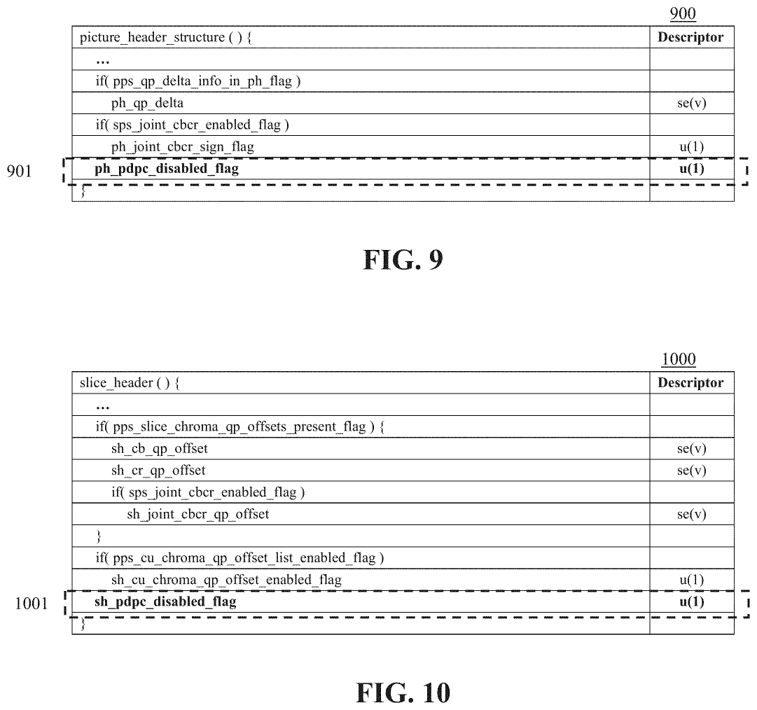

FIG. 9 illustrates an exemplary coding syntax table of a picture header (PH) 900. In some embodiments, a PH flag is introduced to control the PDPC process. The following Table 5 shows the semantics of the proposed PH flag, consistent with the disclosed embodiments.

TABLE 5
Semantics of proposed PH flag for controlling PDPC process

ph_{—}pdpc_{—}disabled_{—}flag equal to 1 specifies that the position-dependent
intra prediction process is disabled for all intra blocks of the current
picture.
ph_pdpc_disabled_flag equal to 0 specifies that the position-dependent
intra prediction process may be enabled for the intra predicted blocks
referring to the PH.

In some embodiments, as shown in FIG. 9, parameter 901 (e.g., ph_pdpc_disabled_flag) equal to 1 specifies that the position-dependent intra prediction process is disabled for all intra blocks of the current picture. For example, ph_pdpc_disabled_flag equal to 0 specifies that the position-dependent intra prediction process may be enabled for the intra predicted blocks referring to the PH. When the parameter 901 is not present, ph_pdpc_disabled_flag can be inferred to be 0.

Table 6 below shows the changes of the decoding process of intra prediction (paragraph “8.4.5.2.5: General intra sample prediction” of VVC draft 9) of the above method as compared to VVC draft 9. Specifically, in Table 6, the proposed changes to the VVC draft 9 are italicized and shown in bold.

TABLE 6
Proposed changes to paragraph 8.4.5.2.5: General intra sample prediction” of VVC draft 9

When all of the following conditions are true, the position-dependent prediction sample filtering process
specified in clause 8.4.5.2.14 of VVC draft 9 is invoked with the intra prediction mode predModeIntra, the
transform block width nTbW, the transform block height nTbH, the predicted samples predSamples[ x ][ y ],
with x = 0...nTbW − 1, y = 0...nTbH − 1, the reference sample width refW, the reference sample height refH,
and the reference samples p[ x ][ y ], with x = −1, y = −1...refH − 1 and x = 0...refW − 1, y = −1 as inputs, and
the output is the modified predicted sample array predSamples.

| | |
|---|---|
| - | [symbol] |
| - | nTbW is greater than or equal to 4 and nTbH is greater than or equal to 4 |
| - | refIdx is equal to 0 or cIdx is not equal to 0 |
| - | BdpcmFlag[ xTbCmp ][ yTbCmp ][ cIdx ] is equal to 0 |
| - | One of the following conditions is true: |
| | - predModeIntra is equal to INTRA_PLANAR |
| | - predModeIntra is equal to INTRA_DC |
| | - predModeIntra is less than or equal to INTRA_ANGULAR18 |
| | - predModeIntra is greater than or equal to INTRA_ANGULAR50 and less than INTRA_LT_CCLM |

FIG. 10 illustrates an exemplary coding syntax table of a slice header (SH) 1000. In some embodiments, a SH flag is introduced to control the PDPC process. FIG. 10 shows semantics of an example for the proposed SH flag. Following is the semantic of the proposed SH flag. The following Table 7 shows the semantics of the proposed SH flag, consistent with the disclosed embodiments.

TABLE 7
Semantics of proposed SH flag for controlling PDPC process

sh_{—}pdpc_{—}disabled_{—}flag equal to 1 specifies that the position-dependent
intra prediction process is disabled for all intra blocks referring to the
current slice.
sh_pdpc_disabled_flag_equal to 0 specifies that the position-dependent
intra prediction process may be enabled for the intra predicted blocks
referring to the current slice.

As shown in FIG. 10, parameter 1001 (e.g., sh_pdpc_disabled_flag) equal to 1 specifies that the position-dependent intra prediction process is disabled for all intra blocks of the current slice. For example, sh_pdpc_disabled_flag equal to 0 specifies that the position-dependent intra prediction process may be enabled for the intra predicted blocks of the current slice. When parameter 1001 is not present, sh_pdpc_disabled_flag can be inferred as 0. FIG. 10 shows the SH syntax table of the above method with changes proposed by the method being shown in bold.

Table 8 below shows the changes of the decoding process of intra prediction (paragraph “8.4.5.2.5: General intra sample prediction” of VVC draft 9) of the above method as compared to VVC draft 9. Specifically, in Table 8, the proposed changes to the VVC draft 9 are italicized and shown in bold.

TABLE 8
Proposed changes to paragraph 8.4.5.2.5: General intra sample prediction” of VVC draft 9

When all of the following conditions are true, the position-dependent prediction sample filtering process
specified in clause 8.4.5.2.14 of VVC draft 9 is invoked with the intra prediction mode predModeIntra, the
transform block width nTbW, the transform block height nTbH, the predicted samples predSamples[ x ][ y ],
with x = 0...nTbW − 1, y = 0...nTbH − 1, the reference sample width refW, the reference sample height refH,
and the reference samples p[ x ][ y ], with x = −1, y = −1...refH − 1 and x = 0...refW − 1, y = −1 as inputs,
and the output is the modified predicted sample array predSamples.

| | |
|---|---|
| - | [symbol] |
| - | nTbW is greater than or equal to 4 and nTbH is greater than or equal to 4 |
| - | refIdx is equal to 0 or cldx is not equal to 0 |
| - | BdpcmFlag[ xTbCmp ][ yTbCmp ][ cIdx ] is equal to 0 |
| - | One of the following conditions is true: |
| | -predModeIntra is equal to INTRA_PLANAR |
| | -predModeIntra is equal to INTRA_DC |
| | -predModeIntra is less than or equal to INTRA_ANGULAR18 |
| | -predModeIntra is greater than or equal to INTRA_ANGULAR50 and less than INTRA_LT_CCLM |

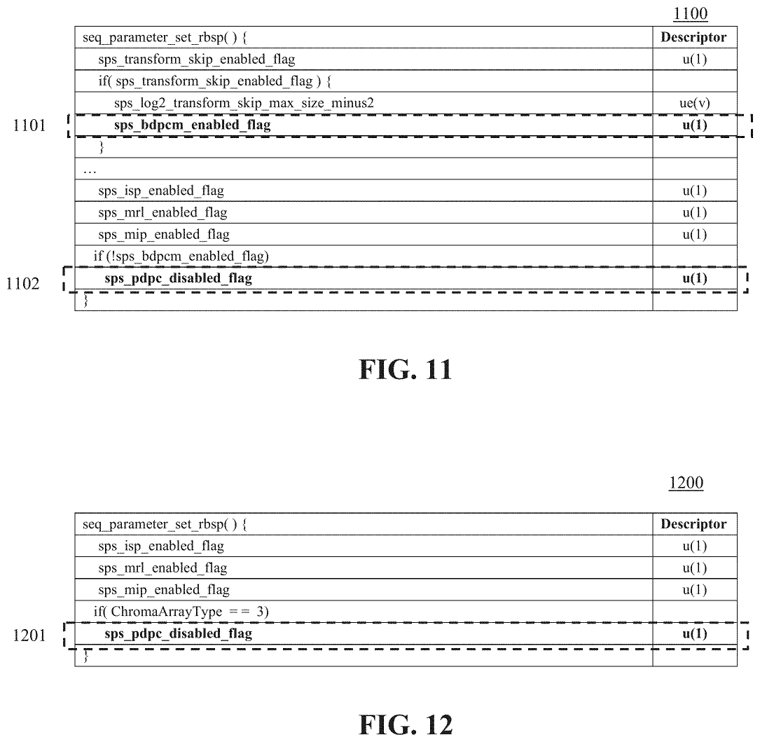

FIG. 11 illustrates an exemplary coding syntax table 1100 of the combination of the SPS flag and a block differential pulse coded modulation (BDPCM) and directed to a high-level control of PDPC when the BDPCM is disabled.

In some embodiments, VVC supports the BDPCM. At the sequence level, a BDPCM enable flag is signaled in the SPS. When the BDPCM is enabled, a flag is transmitted at the CU level to indicate if the BDPCM mode is used or not. In VVC (e.g, VVC draft 9), if an intra block uses the BDPCM mode, PDPC is not applied to that block. Because in screen content sequences, a significant number of intra coded blocks use the BDPCM mode, and PDPC is implicitly disabled for significant number of blocks.

In some embodiments, as shown in FIG. 11, the high level control flags (SPS, PPS, or PH) of PDPC, described in previous embodiments, can only be signaled when SPS level BDPCM is disabled. The detail of the BDPCM process can be found in J. Chen, Y. Ye, S. H. Kim, “Algorithm description for Versatile Video Coding and Test Model 8 (VTM 8)”, JVET-Q2002, January 2020, which is incorporated in the present disclosure by reference.

FIG. 11 shows changes proposed by the method being shown in bold, the parameter 1101 (e.g., sps_pdpc_disabled_flag) is signaled when parameter 1102 (e.g., sps_bdpcm_enabled_flag) is equal to 0. In some embodiments, parameter 801 “PPS flag” (pps_pdpc_disabled_flag, as shown in FIG. 8), parameter 901 “PH flag” (ph_pdpc_disabled_flag, as shown in FIG. 9), and parameter 1001 “SH flag” (sh_pdpc_disabled_flag, as shown in FIG. 10) can only be signaled when parameter 1101 (sps_bdpcm_enabled_flag) is equal to 0.

FIG. 12 illustrates an exemplary coding syntax table of SPS 1200 for 4:4:4 video content. In some embodiments, the parameter 1201 (sps_pdpc_disabled_flag) is directed to a high level control of PDPC for 4:4:4 video content. In 4:4:4 video content, all of the color components have the same number of pixels for a given image frame.

In some embodiments, the high level control flags (e.g., SPS, PPS, or PH) of PDPC, described in previous paragraphs, can only be signaled in the case of only 4:4:4 video sequences. In other words, in the video sequences, ChromaArrayType==3, and the detail of the “ChromaArrayType” can be found in B. Bross, J. Chen, S. Liu, “Versatile Video Coding (Draft 9)”, JVET-R2001, April 2020, which is incorporated in the present disclosure by reference. Moreover, controlling the PDPC only for the 4:4:4 content because of that visual artifact of enabling PDPC is more visible for 4:4:4 video sequences. FIG. 12 shows the syntax table of the combination of parameter 701 of FIG. 7 and the 4:4:4 video sequence, with changes proposed by the method being shown in bold.

In some embodiments, as shown in FIG. 12, parameter 1201 (e.g., sps_pdpc_disabled_flag) is signaled when ChromaArrayType is equal to 3. Following is the semantics of the proposed SPS flag. The following Table 9 shows the semantics of the proposed SPS flag, consistent with the disclosed embodiments.

TABLE 9
Semantics of proposed SPS flag for controlling PDPC process

sps_{—}pdpc_{—}disabled_{—}flag equal to 1 specifies that the position-dependent
intra prediction process is disabled for the CLVS.
sps_pdpc_disabled_flag equal to 0 specifies that the position-dependent
intra prediction process can be enabled for the CLVS.

As shown in FIG. 12, parameter 1201 (e.g., sps_pdpc_disabled_flag) equal to 1 specifies that the PDPC is disabled for the CLVS. For example, parameter 1201 (sps_pdpc_disabled_flag) equal to 0 specifies that the position-dependent intra prediction process can be enabled for the CLVS. When parameter 1201 is not present, parameter 701 (sps_pdpc_disabled_flag) is inferred to be 0.

Table 10 below shows the changes of the decoding process of intra prediction (paragraph “8.4.5.2.5: General intra sample prediction” of VVC draft 9) of the above method as compared to VVC draft 9. Specifically, in Table 10, the proposed changes to the VVC draft 9 are italicized and shown in bold.

TABLE 10
Proposed changes to paragraph 8.4.5.2.5: General intra sample prediction” of VVC draft 9

When all of the following conditions are true, the position-dependent prediction sample filtering process
specified in clause 8.4.5.2.14 of VVC draft 9 is invoked with the intra prediction mode predModeIntra, the
transform block width nTbW, the transform block height nTbH, the predicted samples predSamples[ x ][ y ],
with x = 0...nTbW − 1, y = 0...nTbH − 1, the reference sample width refW, the reference sample height refH,
and the reference samples p[ x ][ y ], with x = −1, y = −1...refH − 1 and x = 0...refW − 1, y = −1 as inputs,
and the output is the modified predicted sample array predSamples.

| | |
|---|---|
| - | [symbol] |
| - | nTbW is greater than or equal to 4 and nTbH is greater than or equal to 4 |
| - | refIdx is equal to 0 or cIdx is not equal to 0 |
| - | BdpcmFlag[ xTbCmp ][ yTbCmp ][ cIdx ] is equal to 0 |
| - | One of the following conditions is true: |
| | -predModeIntra is equal to INTRA_PLANAR |
| | -predModeIntra is equal to INTRA_DC |
| | -predModeIntra is less than or equal to INTRA_ANGULAR18 |
| | -predModeIntra is greater than or equal to INTRA_ANGULAR50 and less than INTRA_LT_CCLM |

In some embodiments, the 4:4:4 video sequences can also be combined with other embodiments in a similar way described in FIG. 12. For example, parameter 801 “PPS flag” (pps_pdpc_disabled_flag, as shown in FIG. 8), parameter 901 “PH flag” (ph_pdpc_disabled_flag, as shown in FIG. 9), and parameter 1001 “SH flag” (sh_pdpc_disabled_flag, as shown in FIG. 10) can only be signaled when ChromaArrayType is equal to 3. In some embodiments, the 4:4:4 video sequences can also be combined with the BDPCM, where the proposed flags are signaled when both ChromaArrayType==3 AND sps_bdpcm_enabled_flag is equal to 0.

Alternatively, parameter 1201 (sps_pdpc_disabled_flag) may be signaled for both 4:4:4 content and 4:2:2 content, but not for 4:2:0 content. In other words, the condition in FIG. 12 may be changed from “ChromaArrayType==3” to “(ChromaArrayType==2 ChromaArrayType==3).”

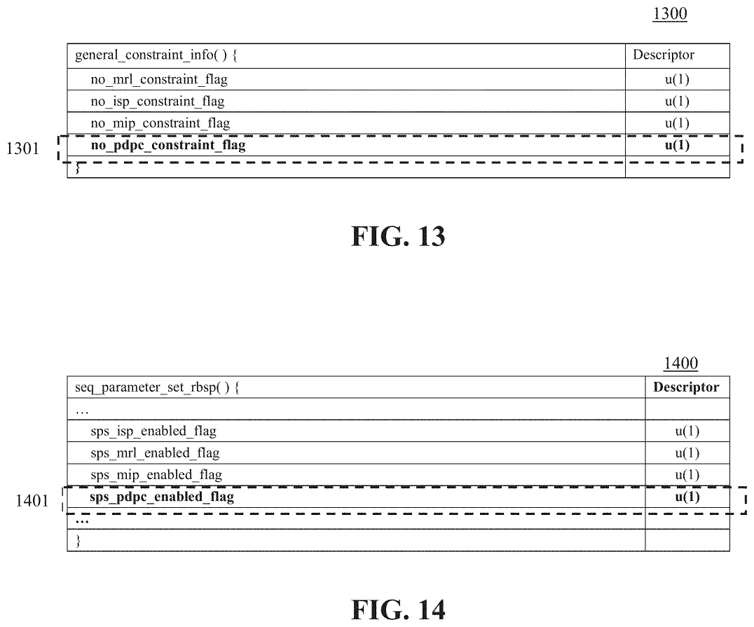

FIG. 13 illustrates an exemplary coding syntax table 1300 directed to a PDPC constraint flag for controlling PDPC. In some embodiments, the VVC provides several constraint flags that can be used to define profiles where certain coding tools are disabled. For example, a constraint flag can be added to disable PDPC. The constraint flag can be combined with any of the previously described embodiments. One example of the semantics of the proposed constraint flag combined with parameter 601 (i.e., signaling of sps_pdpc_disabled_flag) as shown in FIG. 6 is given as below. The following Table 11 shows the semantics of the proposed PDPC constraint flag, consistent with the disclosed embodiments.

TABLE 11
Semantics of proposed PDPC constraint flag

no_{—}pdpc_{—}constraint_{—}flag equal to 1 specifies that the
sps_pdpc_disabled_flag shall be equal to 1.
no_pdpc_constraint_flag equal to 0 does not impose such a constraint.

As shown in FIG. 13, parameter 1301 (e.g., no_pdpc_constraint_flag) equal to 1 specifies that sps_pdpc_disabled_flag shall be equal to 1. For example, parameter 1301 equal to 0 does not impose such a constraint.

FIG. 13 shows the general constraint syntax table of the proposed constraint flag, with changes proposed by the method being shown in bold. Specifically, when parameter 1301 (e.g., no_pdpc_constraint_flag) equal to 1 means PDPC is disabled.

The semantics of the proposed constraint flag can also be defined in terms of the parameter 801 “PPS flag” (pps_pdpc_disabled_flag, shown in FIG. 8), parameter 901 “PH flag” (ph_pdpc_disabled_flag, shown in FIG. 9), and parameter 1001 “SH flag” (sh_pdpc_disabled_flag, FIG. 10).

FIG. 14 illustrates an exemplary coding syntax table 1400 directed to a PDPC control using inverse semantics.

In the previous embodiments, PDPC is controlled by signaling “pdpc_disabled_flag.” In some embodiments, it is proposed to achieve same functionalities of previous embodiments by signaling an enabling flag. For example, parameter 701 (sps_pdpc_disabled_flag, as shown in FIG. 7) can be replaced by parameter 1401 (sps_pdpc_enabled_flag). The semantics of parameter 1401 (sps_pdpc_enabled_flag) is the inverse of parameter 701 (sps_pdpc_disabled_flag) and can be defined as follows. The following Table 12 shows the inverse semantics of the proposed SPS flag, consistent with the disclosed embodiments.

TABLE 12
Inverse semantics of proposed SPS
flag for controlling PDPC process

sps_{—}pdpc_{—}enabled_{—}flag equal to 1 specifies that the position-dependent
intra prediction process may be enabled for the CLVS.
sps_pdpc_disabled_flag equal to 0 specifies that the position-dependent
intra prediction process is disabled for the CLVS.

FIG. 14 shows the SPS syntax table with changes proposed by the method being shown in bold. In some embodiments, parameter 1401 (e.g., sps_pdpc_enabled_flag) equal to 1 specifies that the PDPC may be enabled for the CLVS. For example, parameter 1401 equal to 0 specifies that the PDPC is disabled for the CLVS. When parameter 1401 (sps_pdpc_enabled_flag) is not present, the parameter 1401 can be inferred to be 0.

Table 13 below shows the changes of the decoding process of intra prediction (paragraph “8.4.5.2.5: General intra sample prediction” of VVC draft 9) of the above method as compared to VVC draft 9. Specifically, in Table 13, the proposed changes to the VVC draft 9 are italicized and shown in bold.

TABLE 13
Proposed changes to paragraph 8.4.5.2.5: General intra sample prediction” of VVC draft 9

When all of the following conditions are true, the position-dependent prediction sample filtering process
specified in clause 8.4.5.2.14 of VVC draft 9 is invoked with the intra prediction mode predModeIntra, the
transform block width nTbW, the transform block height nTbH, the predicted samples predSamples[ x ][ y ],
with x = 0...nTbW − 1, y = 0...nTbH − 1, the reference sample width refW, the reference sample height refH,
and the reference samples p[ x ][ y ], with x = −1, y = −1...refH − 1 and x = 0...refW − 1, y = −1 as inputs,
and the output is the modified predicted sample array predSamples.

| | |
|---|---|
| - | [symbol] |
| - | nTbW is greater than or equal to 4 and nTbH is greater than or equal to 4 |
| - | refIdx is equal to 0 or cIdx is not equal to 0 |
| - | BdpcmFlag[ xTbCmp ][ yTbCmp ][ cIdx ] is equal to 0 |
| - | One of the following conditions is true: |
| | -predModeIntra is equal to INTRA_PLANAR |
| | -predModeIntra is equal to INTRA_DC |
| | -predModeIntra is less than or equal to INTRA_ANGULAR18 |
| | -predModeIntra is greater than or equal to INTRA_ANGULAR50 and less than INTRA_LT_CCLM |

The following Table 14 shows the semantics of the proposed PDPC constraint flag for controlling the sps_pdpc_enabled_flag, consistent with the disclosed embodiments.

TABLE 14
Semantics of the proposed PDPC constraint flag

no_{—}pdpc_{—}constraint_{—}flag equal to 1 specifies that the
sps_pdpc_enabled_flag shall be equal to 0.
no_pdpc_constraint_flag equal to 0 does not impose such a constraint.

As shown in FIG. 13, parameter 1301 (e.g., no_pdpc_constraint_flag) equal to 1 specifies that sps_pdpc_enabled_flag shall be equal to 0. For example, when no_pdpc_constraint_flag equal to 0 does not impose such a constraint.

Similar to parameter 1401 (sps_pdpc_enabled_flag), other embodiments can also use inverse semantics. For example, parameter 801 “PPS flag” (pps_pdpc_disabled_flag, as shown in FIG. 8), parameter 901 “PH flag” (ph_pdpc_disabled_flag, FIG. 9), and parameter 1001 “SH flag” (sh_pdpc_disabled_flag, FIG. 10) described in the previous embodiments can be replaced by pps_pdpc_enabled_flag, ph_pdpc_enabled_flag, sh_pdpc_enabled_flag, respectively.

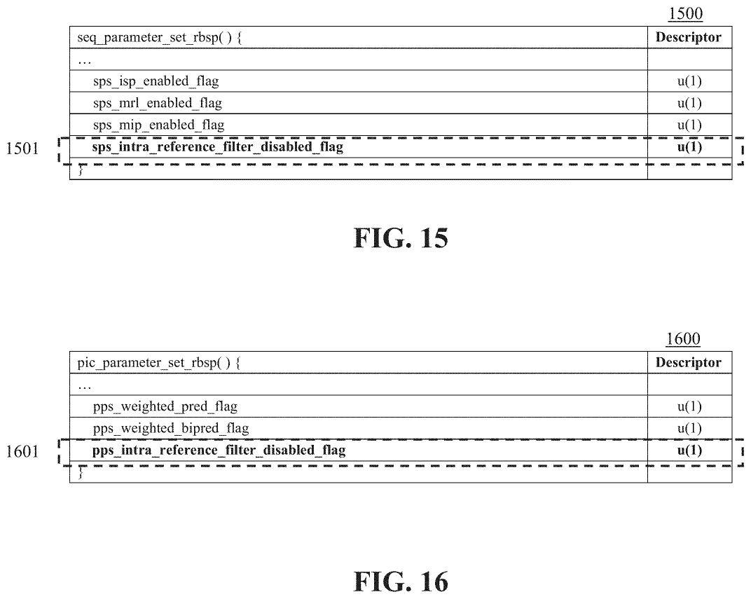

FIG. 15 illustrates an exemplary coding syntax table 1500 directed to a SPS level control of intra reference filter. In some embodiments, an SPS flag is introduced to control the intra reference sample filtering process. The following Table 15 shows the semantics of the proposed SPS flag, consistent with the disclosed embodiments.

TABLE 15
Semantics of the proposed SPS flag for
controlling intra reference filter

sps_{—}intra_{—}reference_{—}filter_{—}disabled_{—}flag equal to 1 specifies that the
intra reference sample filtering process is disabled for the CLVS.
sps_intra_reference_filter_disabled_flag equal to 0 specifies that the
intra reference sample filtering may be enabled for the CLVS.

As shown in FIG. 15, with changes proposed by the method being shown in bold. Parameter 1501 (e.g., sps_intra_reference_filter_disabled_flag) equal to 1 specifies that the intra reference sample filtering process is disabled for the CLVS. For example, parameter 1501 (sps_intra_reference_filter_disabled_flag) is equal to 0 specifies that the intra reference sample filtering process may be enabled for the CLVS. When parameter 1501 (sps_intra_reference_filter_disabled_flag) is not present, the value of parameter 1501 is inferred to be 0.

Table 16 below shows the changes of the decoding process of intra prediction (paragraph “8.4.5.2.5: General intra sample prediction” of VVC draft 9) of the above method as compared to VVC draft 9. Specifically, in Table 16, the proposed changes to the VVC draft 9 are italicized and shown in bold.

TABLE 16
Proposed changes to paragraph 8.4.5.2.5: General
intra sample prediction” of VVC draft 9

The variable refFilterFlag is derived as follows:
- If [symbol] predModeIntra is equal to 0, −14, −12, −10,

−6, 2, 34, 66, 72, 76, 78, or 80, refFilterFlag is set equal to 1.

Otherwise, refFilterFlag is set equal to 0.

FIG. 16 illustrates an exemplary coding syntax table 1600 directed to a PPS level control of intra reference filter. In some embodiments, an PPS flag is introduced to control the intra reference sample filtering process. The following Table 17 shows the semantics of the proposed PPS flag, consistent with the disclosed embodiments.

TABLE 17
Semantics of the proposed PPS flag for
controlling intra reference filter

pps_{—}intra_{—}reference_{—}filter_{—}disabled_{—}flag equal to 1 specifies that the
intra reference sample filtering process is disabled for all intra blocks
referring to the PPS.
pps_intra_reference_filter_disabled_flag equal to 0 specifies that the
intra reference sample filtering may be enabled for the intra predicted
blocks referring to the PPS.

FIG. 16 shows the PPS syntax table with changes proposed by the method being shown in bold. Parameter 1601 (e.g., pps_intra_reference_filter_disabled_flag) equal to 1 specifies that the intra reference sample filtering process is disabled for all intra blocks referring to the PPS. For example, parameter 1601 equal to 0 specifies that the intra reference sample filtering process may be enabled for the intra blocks referring to the PPS. When parameter 1601 is not present, parameter 1601 can be inferred as 0.

Table 18 below shows the changes of the decoding process of intra prediction (paragraph “8.4.5.2.5: General intra sample prediction” of VVC draft 9) of the above method as compared to VVC draft 9. Specifically, in Table 18, the proposed changes to the VVC draft 9 are italicized and shown in bold.

TABLE 18
Proposed changes to paragraph 8.4.5.2.5: General
intra sample prediction” of VVC draft 9

| The variable refFilterFlag is derived as follows: | |
|---|---|
| - | If [symbol] predModeIntra is equal to 0, −14, −12, −10, |
| | −6, 2, 34, 66, 72, 76, 78, or 80, refFilterFlag is set equal to 1. |

Otherwise, refFilterFlag is set equal to 0.

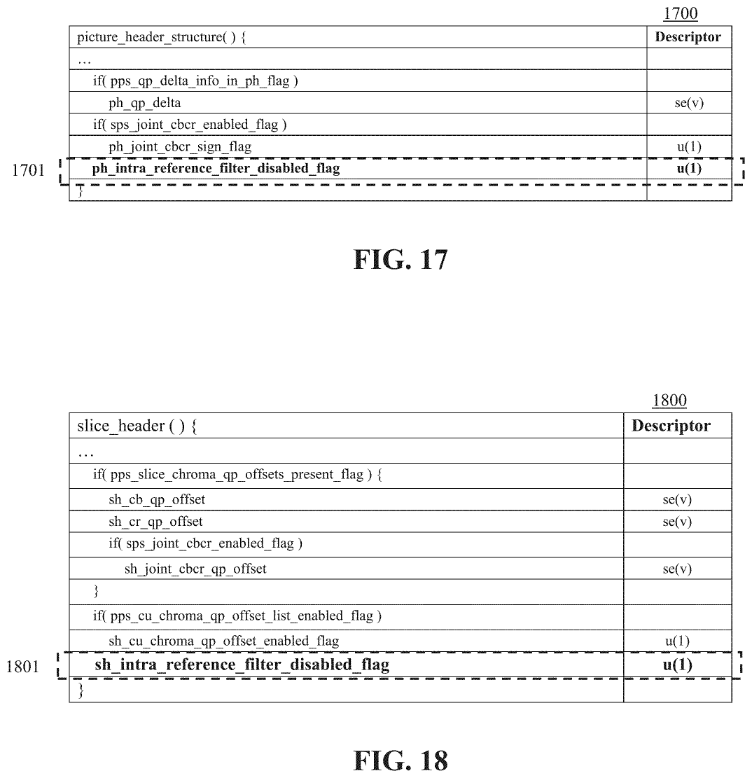

FIG. 17 illustrates an exemplary coding syntax table 1700 directed to a picture header (PH) level control of intra reference filter. In some embodiments, a PH flag is introduced to control the intra reference sample filtering process. The following Table 19 shows the semantics of the proposed PH flag, consistent with the disclosed embodiments.

TABLE 19
Semantics of the proposed PH flag for
controlling intra reference filter

ph_{—}intra_{—}reference_{—}filter_{—}disabled_{—}flag equal to 1 specifies that the
intra reference sample filtering process is disabled for all intra blocks of
the current picture.
ph_intra_reference_filter_disabled_flag equal to 0 specifies that the
intra reference sample filtering may be enabled for the intra blocks
referring of the current picture.

FIG. 17 shows the PH syntax table 1700 of the proposed method, with changes proposed by the method being shown in bold. In some embodiments, parameter 1701 (e.g., ph_intra_reference_filter_disabled_flag) equal to 1 specifies that the intra reference sample filtering process is disabled for all intra blocks of the current picture. For example, parameter 1701 (ph_intra_reference_filter_disabled_flag) is equal to 0 specifies that the intra reference sample filtering process may be enabled for the intra blocks of the current picture. When parameter 1701 (ph_intra_reference_filter_disabled_flag) is not present, parameter 1701 can be inferred as 0.

Table 20 below shows the changes of the decoding process of intra prediction (paragraph “8.4.5.2.5: General intra sample prediction” of VVC draft 9) of the above method as compared to VVC draft 9. Specifically, in Table 20, the proposed changes to the VVC draft 9 are italicized and shown in bold.

TABLE 20
Proposed changes to paragraph 8.4.5.2.5: General
intra sample prediction” of VVC draft 9

| The variable refFilterFlag is derived as follows: | |
|---|---|
| - | If [symbol] predModeIntra is equal to 0, −14, −12, −10, |
| | −6, 2, 34, 66, 72, 76, 78, or 80, refFilterFlag is set equal to 1. |

Otherwise, refFilterFlag is set equal to 0.

FIG. 18 illustrates an exemplary coding syntax table 1800 directed to slice header (SH) level control of intra reference filter. In some embodiments, an SH flag is introduced to control the intra reference sample filtering process. The following Table 21 shows the semantics of the proposed SH flag, consistent with the disclosed embodiments.

TABLE 21
Semantics of the proposed SH flag for
controlling intra reference filter

sh_{—}intra_{—}reference_{—}filter_{—}disabled_{—}flag equal to 1 specifies that the
intra reference sample filtering process is disabled for all intra blocks of
the slice.
sh_intra_reference_filter_disabled_flag equal to 0 specifies that the
intra reference sample filtering may be enabled for the intra blocks
referring of the current slice.

FIG. 18 shows the SH syntax table 1800 of the proposed method, with changes proposed by the method being shown in bold. In some embodiments, parameter 1801 (e.g., sh_intra_reference_filter_disabled_flag) equal to 1 specifies that the intra reference sample filtering process is disabled for all intra blocks of the slice. For example, parameter 1801 (sh_intra_reference_filter_disabled_flag) equal to 0 specifies that the intra reference sample filtering process may be enabled for the intra block of the current slice. When parameter 1801 (sh_intra_reference_filter_disabled_flag) is not present, parameter 1801 can be inferred as 0.

Table 22 below shows the changes of the decoding process of intra prediction (paragraph “8.4.5.2.5: General intra sample prediction” of VVC draft 9) of the above method as compared to VVC draft 9. Specifically, in Table 22, the proposed changes to the VVC draft 9 are italicized and shown in bold.

TABLE 22
Proposed changes to paragraph 8.4.5.2.5: General
intra sample prediction” of VVC draft 9

The variable refFilterFlag is derived as follows:

| | |
|---|---|
| - | If [symbol] predModeIntra is equal to 0, −14, −12, |
| | −10, −6, 2, 34, 66, 72, 76, 78, or 80, refFilterFlag is set equal to 1. |

Otherwise, refFilterFlag is set equal to 0.

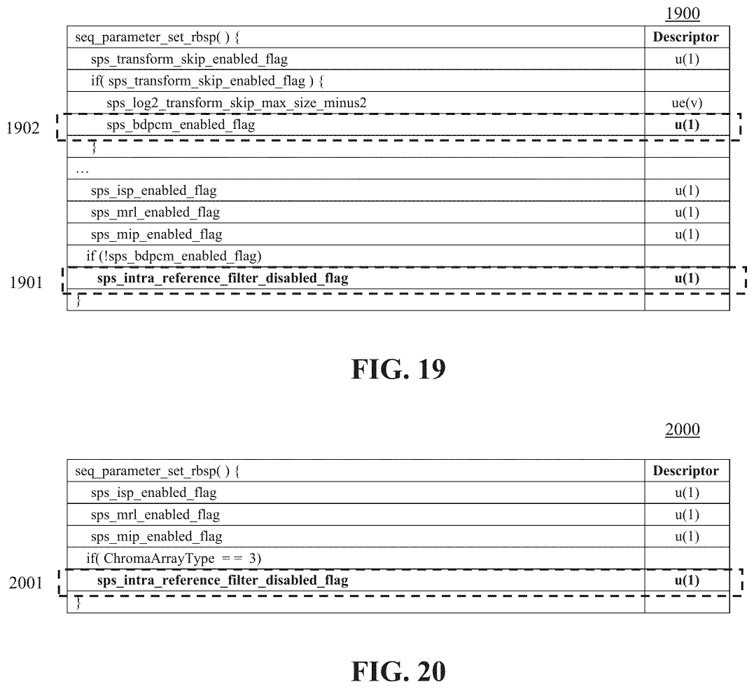

FIG. 19 illustrates an exemplary coding syntax table 1900 directed to a SPS level control of intra reference sample filtering when the BDPCM is disabled.

In some embodiments, the high level control flags (SPS, PPS, or PH) of intra reference sample filtering process, described in previous embodiments, is conditionally signaled when SPS level BDPCM is disabled. The details of the BDPCM process can be found in J. Chen, Y. Ye, S. H. Kim, “Algorithm description for Versatile Video Coding and Test Model 8 (VTM 8)”, JVET-Q2002, January 2020, which is incorporated in the present disclosure by reference.

FIG. 19 shows the syntax table 1900 of the combination of the SPS flag of intra reference filtering process with the BDPCM, with changes proposed by the method being shown in bold. The following Table 23 shows the semantics of the proposed SPS flag, consistent with the disclosed embodiments.

TABLE 23
Semantics of the proposed SPS flag for
controlling intra reference filter

sps_{—}intra_{—}reference_{—}filter_{—}disabled_{—}flag equal to 1 specifies that the
intra reference sample filtering process is disabled for the CLVS.
sps_intra_reference_filter_disabled_flag equal to 0 specifies that the
intra reference sample filtering may be enabled for the CLVS.

As shown in FIG. 19, with changes proposed by the method being shown in bold. In some embodiments, parameter 1901 (sps_intra_reference_filter_disabled_flag) equal to 1 specifies that the intra reference sample filtering process is disabled for the CLVS. For example, parameter 1901 (sps_intra_reference_filter_disabled_flag) is equal to 0 specifies that the intra reference sample filtering process may be enabled for the CLVS. When parameter 1901 (sps_intra_reference_filter_disabled_flag) is not present, the value of parameter 1901 is inferred to be 0.

Following paragraph shows changes of the decoding process of intra prediction (paragraph “8.4.5.2.5: General intra sample prediction of the VVC draft 9) of the proposed method. The addition as compared to VVC draft 9 is shown below. The variable refFilterFlag is derived as follows: If sps_intra_reference_filter_disabled_flag is equal to 0 and predModeIntra is equal to 0, −14, −12, −10, −6, 2, 34, 66, 72, 76, 78, or 80, refFilterFlag is set equal to 1. Otherwise, refFilterFlag is set equal to 0.

In some embodiments, parameter 1601 “PPS flag” (pps_intra_reference_filter_disabled_flag, as shown in FIG. 16), parameter 1701 “PH flag” (ph_intra_reference_filter_disabled_flag, as shown in FIG. 17), and parameter 1801, “SH flag” (sh_intra_reference_filter_disabled_flag, as shown in FIG. 18) described in the previous embodiments can only be signaled when parameter 1902 (sps_bdpcm_enabled_flag) is equal to 0.

FIG. 20 illustrates an exemplary coding syntax table 2000 directed to a SPS level control of intra reference sample filtering for 4:4:4 video content. In some embodiments, the high level control flags (e.g., SPS, PPS, or PH) of intra reference filtering process, described in previous embodiments, can only be signaled in case of only 4:4:4 video sequences (e.g., ChromaArrayType==3). The detail of the ChromaArrayType can be found in B. Bross, J. Chen, S. Liu, “Versatile Video Coding (Draft 9)”, JVET-R2001, April 2020, which is incorporated in the present disclosure by reference.

FIG. 20 shows the syntax table 2000 of the combination of SPS flag control of intra reference filtering with 4:4:4 content, with changes proposed by the method being shown in bold. Parameter 2001 (e.g., sps_intra_reference_filter_disabled_flag) is signaled when ChromaArrayType is equal to 3. The following Table 24 shows the semantics of the proposed SPS flag, consistent with the disclosed embodiments.

TABLE 24
Semantics of the proposed SPS flag for
controlling intra reference filter

sps_{—}intra_{—}reference_{—}filter_{—}disabled_{—}flag equal to 1 specifies that the
intra reference sample filtering process is disabled for the CLVS.
sps_intra_reference_filter_disabled_flag equal to 0 specifies that the
intra reference sample filtering may be enabled for the CLVS.

As shown in FIG. 20, parameter 2001 (sps_intra_reference_filter_disabled_flag) equal to 1 specifies that the intra reference sample filtering process is disabled for the CLVS. For example, parameter 2001 (sps_intra_reference_filter_disabled_flag) is equal to 0 specifies that the intra reference sample filtering process may be enabled for the CLVS. When parameter 2001 (sps_intra_reference_filter_disabled_flag) is not present, the value of parameter 2001 is inferred to be 0.

Following paragraph shows changes of the decoding process of intra prediction (paragraph “8.4.5.2.5: General intra sample prediction of the VVC draft 9) of the proposed method. The addition as compared to VVC draft 9 is shown below. The variable refFilterFlag is derived as follows: If sps_intra_reference_filter_disabled_flag is equal to 0 and predModeIntra is equal to 0, −14, −12, −10, −6, 2, 34, 66, 72, 76, 78, or 80, refFilterFlag is set equal to 1. Otherwise, refFilterFlag is set equal to 0.

In some embodiments, parameter 1601 “PPS flag” (pps_intra_reference_filter_disabled_flag, as shown in FIG. 16), parameter 1701 “PH flag” (ph_intra_reference_filter_disabled_flag, as shown in FIG. 17), and parameter 1801 “SH flag” (sh_intra_reference_filter_disabled_flag, as shown in FIG. 18) described in the previous embodiments can only be signaled when ChromaArrayType is equal to 3. In some embodiments, where the proposed flags are signaled when both ChromaArrayType==3 and parameter 1901 (sps_bdpcm_enabled_flag, as shown in FIG. 19) is equal to 0.

Alternatively, parameter 2001 (sps_intra_reference_filter_disabled_flag) may be signaled for both 4:4:4 content and 4:2:2 content, but not for 4:2:0 content. In other words, the condition in FIG. 20 may be changed from “ChromaArrayType==3” to “(ChromaArrayType==2 ChromaArrayType==3).”

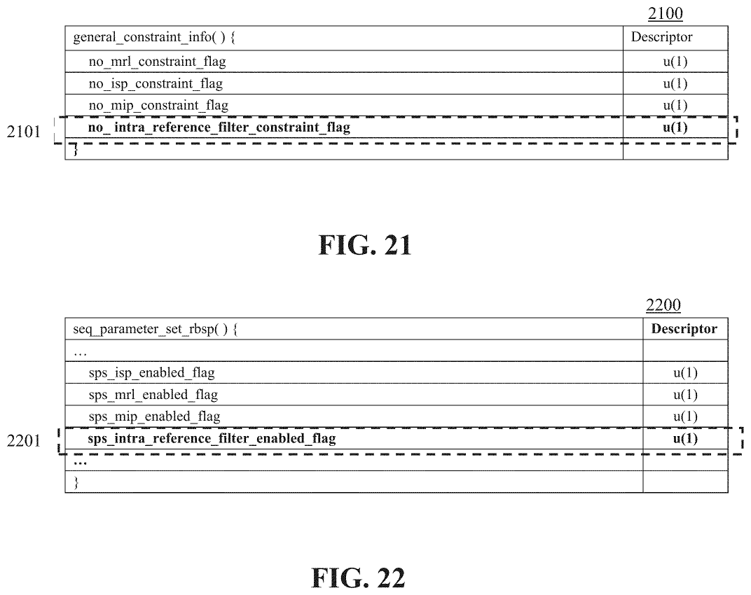

FIG. 21 illustrates an exemplary coding syntax table 2100 directed to a constraint flag of intra reference sample filtering. In some embodiments, a constraint flag can be added to disable intra reference sample filtering. The proposed constraint flag can be combined with any of the previously proposed embodiments. One example of the semantics of the proposed constraint flag combined with the parameter 1501 (i.e., signaling of sps_intra_reference_filter_disabled_flag), as shown in FIG. 15, is given below.

The following Table 25 shows the semantics of the proposed intra reference filter constraint flag, consistent with the disclosed embodiments.

TABLE 25
Semantics of the proposed intra reference filter constraint flag

no_{—}intra_{—}reference_{—}filter_{—}constraint_{—}flag equal to 1 specifies that the
sps_intra_reference_filter_disabled_flag shall be equal to 0.
no_intra_reference_filter_constraint_flag equal to 0 does not impose
such a constraint.

In some embodiments, parameter 2101 (e.g., no_intra_reference_filter_constraint_flag equal) to 1 specifies that parameter 1501 (sps_intra_reference_filter_disabled_flag), as shown in FIG. 15, shall be equal to 1. For example, when parameter 2101 (no_intra_reference_filter_constraint_flag) equal to 0 does not impose such a constraint.

FIG. 21 shows the general constraint syntax table 2100 of the parameter 2101 (no_intra_reference_filter_constraint_flag) equal to 1 means intra reference filtering process is disabled, with changes proposed by the method being shown in bold.

The semantics of the proposed constraint flag can also be defined in terms of the parameter 1601 “PPS flag” (pps_intra_reference_filter_disabled_flag, shown in FIG. 16), parameter 1701 “PH flag” (ph_intra_reference_filter_disabled_flag, shown in FIG. 17), and 1801 SH flag (sh_intra_reference_filter_disabled_flag, shown in FIG. 18).

FIG. 22 illustrates an exemplary coding syntax table 2200 directed to the control of intra reference sample filtering using inverse semantics.

In the previous embodiments, it was proposed to control intra reference filter by signaling “_intra_reference_filter_disabled_flag”. In some embodiment, as shown in FIG. 22, it is proposed to achieve same functionalities of the previous embodiments by signaling enabled flag. For example, parameter 2001 (sps_intra_reference_filter_disabled_flag, as shown in FIG. 20) can be replaced by parameter 2201 (sps_intra_reference_filter_enabled_flag). The semantics of parameter 2201 (sps_intra_reference_filter_enabled_flag) is the inverse of parameter 2201 (sps_intra_reference_filter_disabled_flag, as shown in FIG. 22) and can be defined as follows.

The following Table 26 shows the inverse semantics of the proposed SPS flag, consistent with the disclosed embodiments.

TABLE 26
Inverse semantics of the proposed SPS flag
for controlling intra reference filter

sps_{—}intra_{—}reference_{—}filter_{—}enabled_{—}flag equal to 1 specifies that the
intra reference sample filtering process may be enabled for the CLVS.
sps_intra_reference_filter_enabled_flag equal to 0 specifies that the
intra reference sample filtering is disabled for the CLVS.

In some embodiments, parameter 2201 (e.g., sps_intra_reference_filter_enabled_flag) equal to 1 specifies that the intra reference filtering process may be enabled for the CLVS. For example, parameter 2201 sps_intra_reference_filter_enabled_flag equal to 0 specifies that the intra reference filtering process is disabled for the CLVS. When parameter 2201 (sps_intra_reference_filter_enabled_flag) is not present, parameter 2201 can be inferred to be 0. FIG. 22 shows the SPS syntax table of the proposed method, with changes proposed by the method being shown in bold.

Table 27 below shows the changes of the decoding process of intra prediction (paragraph “8.4.5.2.5: General intra sample prediction” of VVC draft 9) of the above method as compared to VVC draft 9. Specifically, in Table 27, the proposed changes to the VVC draft 9 are italicized and shown in bold.

TABLE 27
Proposed changes to paragraph 8.4.5.2.5: General
intra sample prediction” of VVC draft 9

| The variable refFilterFlag is derived as follows: | |
|---|---|
| - | If [symbol] predModeIntra is equal to 0, −14, −12, −10, |
| | −6, 2, 34, 66, 72, 76, 78, or 80, refFilterFlag is set equal to 1. |
| - | Otherwise, refFilterFlag is set equal to 0 |

The semantics of the intra reference filter constraint flag using parameter 2201 (sps_intra_reference_filter_enabled_flag) can be defined as follows.

The following Table 28 shows the semantics of the proposed PDPC constraint flag, consistent with the disclosed embodiments.

TABLE 28
Semantics of the proposed intra reference filter constraint flag

no_{—}intra_{—}reference_{—}filter_{—}constraint_{—}flag equal to 1 specifies that the
sps_intra_reference_filter_enabled_flag shall be equal to 0.
no_intra_reference_filter_constraint_flag equal to 0 does not impose
such a constraint.

In some embodiments, parameter 2101 (no_intra_reference_filter_constraint_flag as shown in FIG. 21) equal to 1 specifies that parameter 2201 sps_intra_reference_filter_enabled_flag shall be equal to 0. For example, when parameter 2101 (no_intra_reference_filter_constraint_flag as shown in FIG. 21) equal to 0 does not impose such a constraint.

Similar to parameter 2201 (sps_intra_reference_filter_enabled_flag), some embodiments can also be combined with other embodiment in a similar way. For example, the parameter 1601 “PPS flag” (pps_intra_reference_filter_disabled_flag, as shown in FIG. 16), the parameter 1701 “PH flag” (ph_intra_reference_filter_disabled_flag, as shown in FIG. 17), and parameter 1801 “SH flag” (sh_intra_reference_filter_disabled_flag, as shown in FIG. 18) described in the previous embodiments can be replaced by pps_intra_reference_filter_enabled_flag, ph_intra_reference_filter_enabled_flag, sh_intra_reference_filter_enabled_flag, respectively.

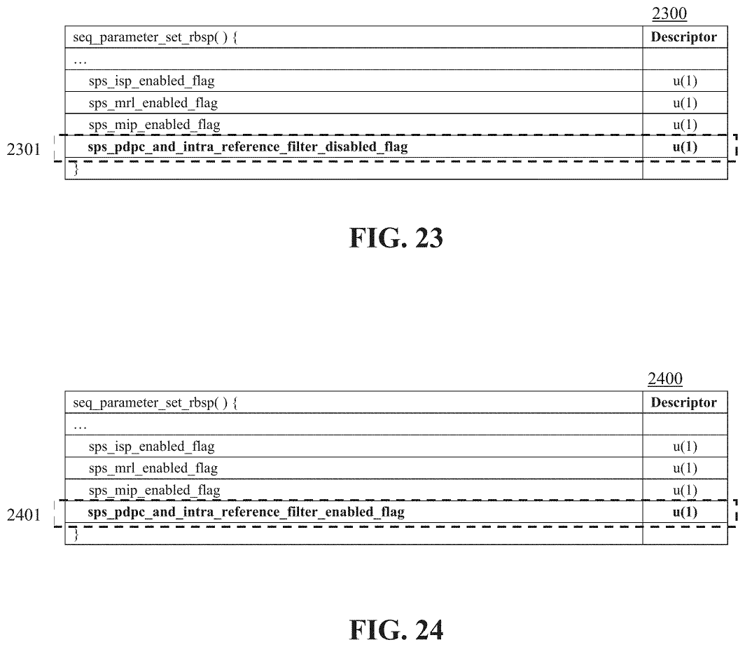

FIG. 23 illustrates an exemplary coding syntax table 2300 directed to a single SPS flag to control both PDPC and intra reference filter. In some embodiments, a single SPS flag is introduced to control both PDPC and the intra reference sample filtering process. The following Table 29 shows the semantics of the proposed SPS flag, consistent with the disclosed embodiments.

TABLE 29
Semantics of the proposed SPS flag for controlling
both PDPC and intra reference filter

sps_{—}pdpc_{—}intra_{—}reference_{—}filter_{—}disabled_{—}flag equal to 1
specifies that both PDPC and the intra reference sample filtering process
are disabled for the CLVS.
sps_pdpc_and_intra_reference_filter_disabled_flag equal to 0
specifies that PDPC and the intra reference sample filtering process may
be enabled for the CLVS.

As shown in FIG. 23, parameter 2301 (sps_pdpc_and_intra_reference_filter_disabled_flag) equal to 1 specifies that both PDPC and the intra reference sample filtering process are disabled for the CLVS. For example, parameter 2301 (sps_pdpc_and_intra_reference_filter_disabled_flag) equal to 0 specifies that PDPC and the intra reference sample filtering process may be enabled for the CLVS. When parameter 2301 is not present, the value of parameter 2301 (sps_pdpc_and_intra_reference_filter_disabled_flag) can be inferred to be 0. FIG. 23 shows the SPS syntax table 2300 of the proposed method, with changes proposed by the method being shown in bold.

Table 30 below shows the changes of the decoding process of intra prediction (paragraph “8.4.5.2.5: General intra sample prediction” of VVC draft 9) of the above method as compared to VVC draft 9. Specifically, in Table 30, the proposed changes to the VVC draft 9 are italicized and shown in bold.

TABLE 30
Proposed changes to paragraph 8.4.5.2.5: General intra sample prediction” of VVC draft 9

When all of the following conditions are true, the position-dependent prediction sample filtering process specified
in clause 8.4.5.2.14 is invoked with the intra prediction mode predModeIntra, the transform block width nTbW,
the transform block height nTbH, the predicted samples predSamples[ x ][ y ], with x = 0..nTbW − 1,
y = 0..nTbH − 1, the reference sample width refW, the reference sample height refH, and the reference samples
p[ x ][ y ], with x = −1, y = −1..refH − 1 and x = 0..refW − 1, y = −1 as inputs, and the output is the modified
predicted sample array predSamples:

| - | [symbol] | |
|---|---|---|
| - | nTbW is greater than or equal to 4 and nTbH is greater than or equal to 4 | |
| - | refIdx is equal to 0 or cIdx is not equal to 0 | |
| - | BdpcmFlag[ xTbCmp ][ yTbCmp ][ cIdx ] is equal to 0 | |
| - | One of the following conditions is true: | |
| | - | predModeIntra is equal to INTRA_PLANAR |
| | - | predModeIntra is equal to INTRA_DC |
| | - | predModeIntra is less than or equal to INTRA_ANGULAR18 |

predModeIntra is greater than or equal to INTRA_ANGULAR50 and less than INTRA_LT_CCLM

Table 31 below shows the changes of the decoding process of intra prediction (paragraph “8.4.5.2.5: General intra sample prediction” of VVC draft 9) of the above method as compared to VVC draft 9. Specifically, in Table 31, the proposed changes to the VVC draft 9 are italicized and shown in bold.

TABLE 31
Proposed changes to paragraph 8.4.5.2.5: General
intra sample prediction” of VVC draft 9

The variable refFilterFlag is derived as follows:

| | |
|---|---|
| - | If [symbol] predModeIntra is equal to 0, −14, |
| | −12, −10, −6, 2, 34, 66, 72, 76, 78, or 80, refFilterFlag is set equal to 1. |

Otherwise, refFilterFlag is set equal to 0

Similar to the SPS flag described in previous embodiments, a single PPS/PH/SH flag can also be used to control both PDPC and intra reference sample filtering process.

In some embodiments, the same functionality of a single SPS flag is introduced to control both PDPC and the intra reference sample filtering process can also be achieve by signaling sps_pdpc_and_intra_reference_filter_enabled_flag instead of parameter 2301 sps_pdpc_and_intra_reference_filter_disabled_flag. In that case, the semantics of the sps_pdpc_and_intra_reference_filter_enabled_flag can be defined as follows.

FIG. 24 illustrates an exemplary coding syntax table 2400 directed to a single SPS flag to control both PDPC and intra reference filter using inverse semantics. The following Table 32 shows the inverse semantics of the proposed SPS flag, consistent with the disclosed embodiments.

TABLE 32
Inverse semantics of the proposed SPS flag for controlling
both PDPC and intra reference filtering

sps_{—}pdpc_{—}and_{—}intra_{—}reference_{—}filter_{—}enabled_{—}flag equal to 1
specifies that both PDPC and the intra reference sample filtering process
may be enabled for the CLVS.
sps_pdpc_and_intra_reference_filter_enabled_flag equal to 0 specifies
that both PDPC and the intra reference sample filtering process may be
disabled for the CLVS

As shown in FIG. 24, parameter 2401 (e.g., sps_pdpc_and_intra_reference_filter_enabled_flag) equal to 1 specifies that PDPC and the intra reference sample filtering process may be enabled for the CLVS. For example, parameter 2401 (sps_pdpc_and_intra_reference_filter_enabled_flag) is equal to 0 specifies that both PDPC and the intra reference sample filtering process are disabled for the CLVS. When parameter 2401 sps_pdpc_and_intra_reference_filter_enabled_flag) is not present, the value of parameter 2401 can be inferred to be 0.

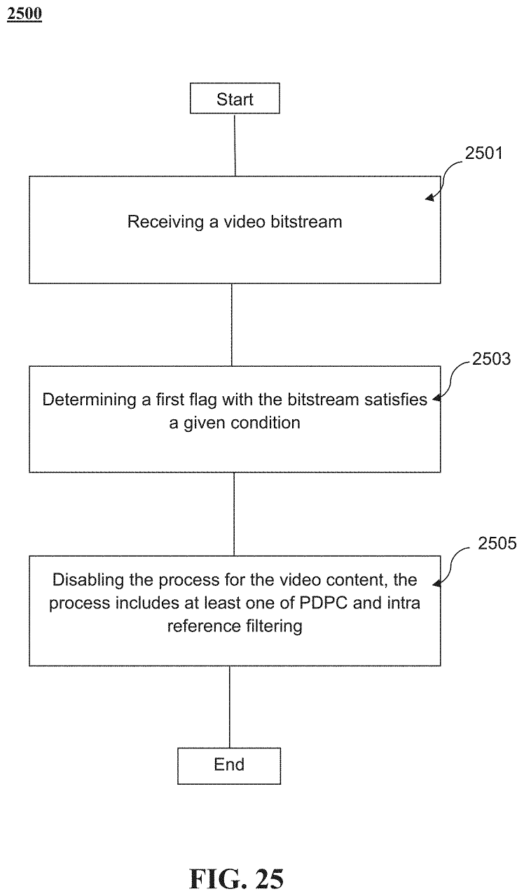

Embodiments of the present disclosure further include methods for high level control of PDPC and intra reference filtering of video coding. FIGS. 25-30 show flow charts of an example of a process of video decoding. In some embodiments, methods 2500-3000 shown in FIGS. 25-30 can be performed by apparatus 400 shown in FIG. 4.

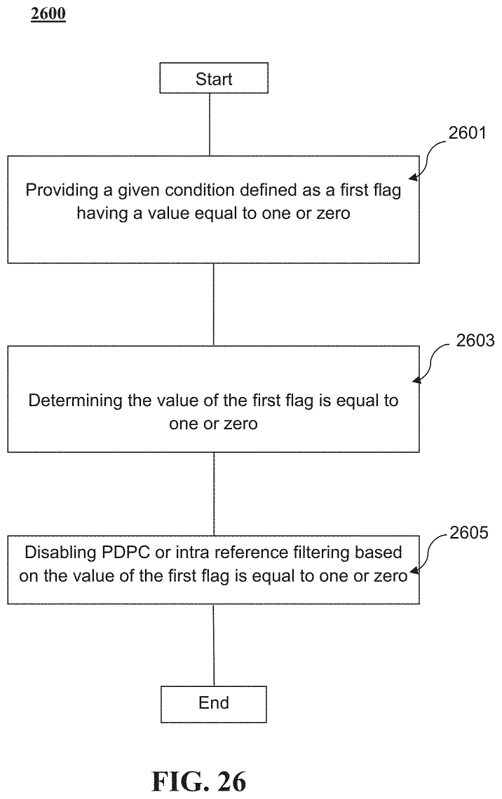

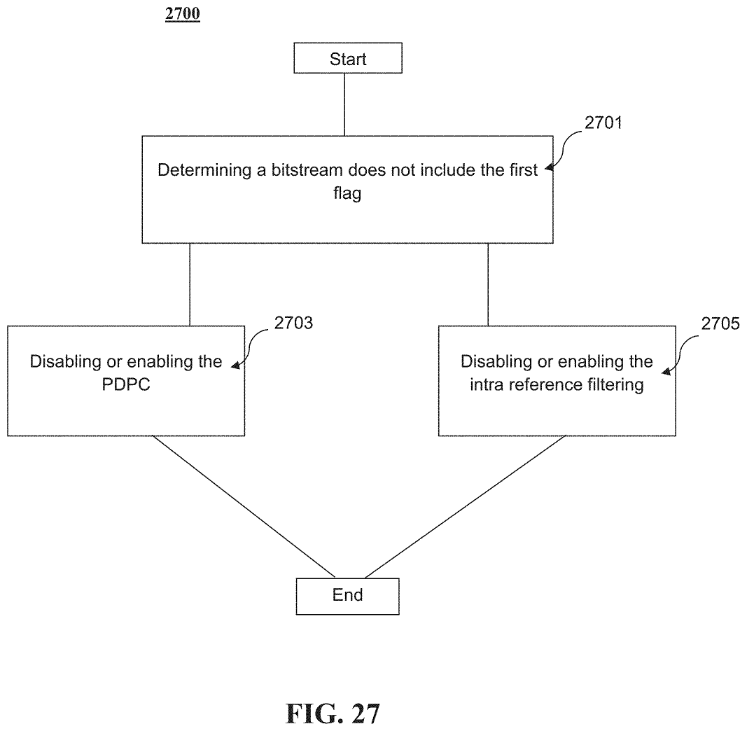

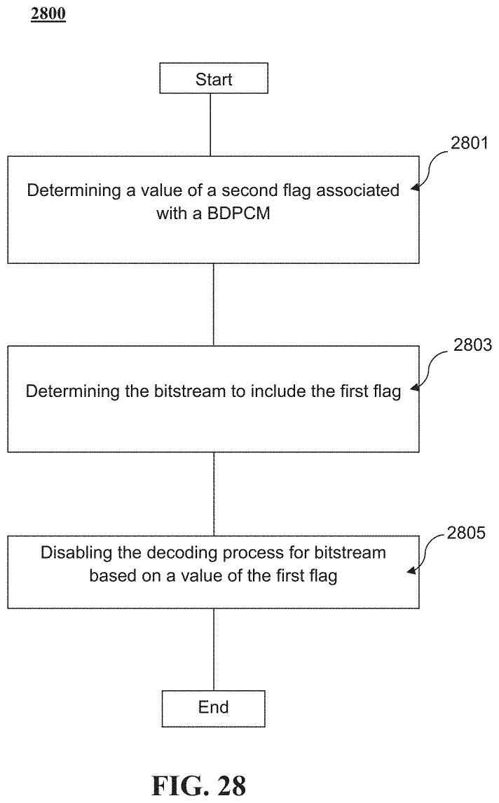

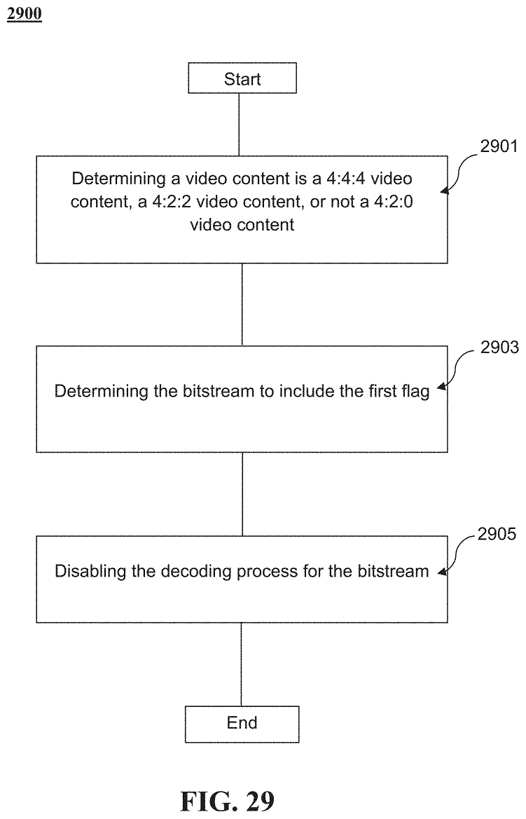

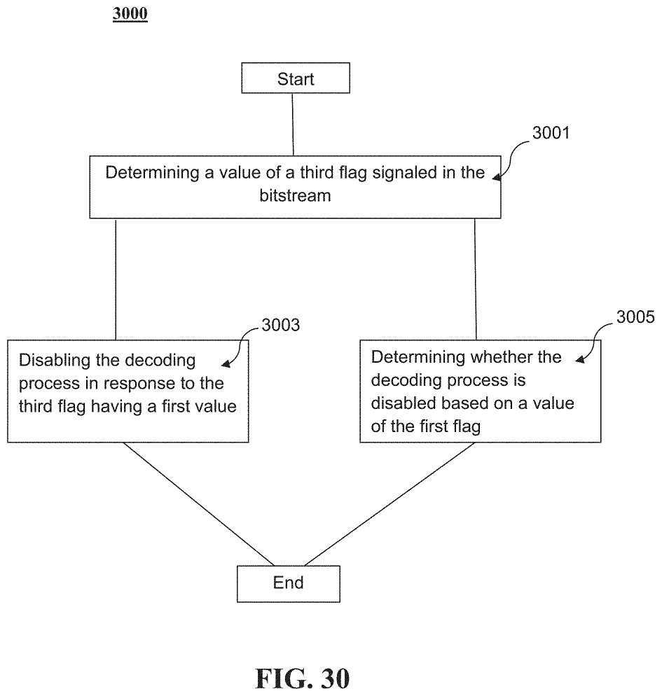

As shown in FIG. 25, according to some embodiments, upon receiving a video bitstream in step S2501, a first flag can be determined with the bitstream satisfied a given condition in step S2502 and the method 2500 may proceed to step S2503. In step S2505, a decoding process for the bitstream can be disabled based on the first flag satisfied a given condition, the decoding process includes at least one of PDPC and intra reference filtering. As shown in FIG. 26, according to some embodiments, upon providing a given condition defined as a first flag having a value equal to one or zero in step S2601, the value of the first flag can be determined equal to one or zero in step S2603 and the method 2600 may proceed to step S2605. In step S2605, PDPC or intra reference filtering can be disabled based on the value of the first flag is equal to one or zero. As shown in FIG. 27, according to some embodiments, upon determining the bitstream does not include the first flag in step S2701, disabling or enabling the PDPC in step S2703, disabling or enabling the intra reference filtering in step S2705. As shown in FIG. 28, according to some embodiments, upon determining a value of a second flag associated with a BDPCM in step S2801, the bitstream is determined to include the first flag in step S2803 and the method 2800 may proceed to step S2805. In step S2805, the decoding process is disabled based on a value of the first flag. As shown in FIG. 29, upon determining a video content is a 4:4:4 video, a 4:2:2 video content, or not a 4:2:0 video content, the bitstream is determined to include the first flag in step S2903 and the method 2900 may proceed to step S2905. In step S2905, the decoding process is being disabled based on the value of the first flag. As shown in FIG. 30, upon determining a value of a third flag signaled in the bitstream in step S3001, and the method 3000 may proceed to next steps, disabling the decoding process in response to the third flag having a first value in step S3003 or determining whether the decoding process is disabled based on a value of the first flag in step S3005.

In view of above, as proposed in various embodiments of the present disclosure, by determining whether a first flag associated with a process for the video content satisfies a given condition; and in response to the determination that the signal satisfies the given condition, disabling the process includes at least one of the PDPC and intra reference filtering, the coding method of syntax structure number and syntax structure index between SPS, PPS, PH, and SH parameters can be consistent and efficient. In addition, by disabling PDPC and intra reference filtering for texts, graphics, computer screen can further improve the coding efficiency.

The methods shown in FIGS. 25-30 are for illustrative purpose and are described below from the perspective of a decoder. However, it is contemplated that a video encoder can perform all or a subset of the inverse operations of the decoding operations. Unless otherwise noted, techniques of video decoding described in the present disclosure are also intended to encompass the inverse of the disclosed video encoding techniques (i.e., video encoding techniques associated with the disclosed video decoding techniques), and vice versa.

The embodiments may further be described using the following clauses:
1. A computer-implemented video decoding method, comprising:
   receiving a video bitstream;
   determining whether a first flag associated with the bitstream satisfies a given condition; and
   in response to a determination that the first flag satisfies the given condition, disabling a decoding process for the bitstream, wherein the decoding process comprises at least one of position dependent intra prediction combination (PDPC) and intra reference filtering.
2. The method of clause 1, wherein the first flag is signaled in a sequence parameter set (SPS), a picture parameter set (PPS), a picture header (PH), or a slice header (SH).
3. The method of clause 1, wherein the given condition comprises the first flag having a value equal to one or zero.
4. The method of clause 3, further comprising:
   determining the value of the first flag; and
   in response to a determination that the first flag is equal to one, disabling the PDPC.
5. The method of clause 3, further comprising:
   determining the value of the first flag; and
   in response to a determination that the first flag is equal to zero, disabling the PDPC.
6. The method of clause 3, further comprising:
   determining the value of the first flag; and
   in response to a determination that the first flag is equal to one, disabling the intra reference filtering.
7. The method of clause 3, further comprising:
   determining the value of the first flag; and
   in response to a determination that the first flag is equal to zero, disabling the intra reference filtering.
8. The method of clause 1, further comprising:
   determining whether the bitstream includes the first flag; and
   in response to a determination that the bitstream does not include the first flag, disabling the PDPC.
9. The method of clause 1, further comprising:
   determining whether the bitstream includes the first flag; and
   in response to a determination that the bitstream does not include the first flag, enabling the PDPC.
10. The method of clause 1, further comprising:
   determining whether the bitstream includes the first flag; and
   in response to a determination that the bitstream does not include the first flag, disabling the intra reference filtering.
11. The method of clause 1, further comprising:
   determining whether the bitstream includes the first flag; and
   in response to a determination that the bitstream does not include the first flag, enabling the intra reference filtering.
12. The method of clause 1, further comprising:
   determining a value of a second flag associated with a block differential pulse coded modulation (BDPCM);
   in response to the second flag having a first value, determining that the bitstream includes the first flag; and
   determining, based on a value of the first flag, whether the decoding process is disabled.
13. The method of clause 1, further comprising:
   determining whether the bitstream is a 4:4:4 video bitstream;
   in response to the bitstream being the 4:4:4 video bitstream, determining that the bitstream includes the first flag; and
   determining, based on a value of the first flag, whether the decoding process is disabled.
14. The method of clause 1, further comprising:
   determining whether the bitstream is a 4:2:2 bitstream;
   in response to the bitstream being the 4:2:2 video bitstream, determining that the bitstream includes the first flag; and
   determining, based on a value of the first flag, whether the decoding process is disabled.
15. The method of clause 1, further comprising:
   determining whether the bitstream is a 4:2:0 video bitstream;
   in response to a determination that the bitstream is not the 4:2:0 bitstream content, determining that the bitstream includes the first flag; and
   determining, based on a value of the first flag, whether the decoding process is disabled.
16. The method of clause 1, further comprising:
   determining a value of a third flag signaled in the bitstream; and
   in response to the third flag having a first value, disabling the decoding process, or
   in response to the third flag having a second value, determining, based on a value of the first flag, whether the decoding process is disabled.
17. The method of clause 16, wherein the third flag is a constraint flag.
18. A system for decoding video data, the system comprising:
   a memory storing a set of instructions; and
   a processor configured to execute the set of instructions to cause the system to perform:
      receiving a video bitstream;
      determining whether a first flag associated with the bitstream satisfies a given condition; and
      in response to the determination that the first flag satisfies the given condition, disabling a decoding process for the video content, wherein the decoding process comprises at least one of position dependent intra prediction combination (PDPC) and intra reference filtering.
19. The system of clause 18, wherein the first flag is signaled in a sequence parameter set (SPS), a picture parameter set (PPS), a picture header (PH), or a slice header (SH).
20. The system of clause 18, wherein the given condition comprises the first flag having a value equal to one or zero.
21. The system of clause 20, wherein the processor is further configured to execute the set of instruction to cause the system to perform:
   determining the value of the first flag; and
   in response to a determination that the first flag is equal to one, disabling the PDPC.
22. The system of clause 20, wherein the processor is further configured to execute the set of instructions to cause the system to perform:
   determining the value of the first flag; and
   in response to a determination that the first flag is equal to zero, disabling the PDPC.
23. The system of clause 20, wherein the processor is further configured to execute the set of instruction to cause the system to perform:
   determining the value of the first flag; and
   in response to a determination that the first flag is equal to one, disabling the intra reference filtering.
24. The system of clause 20, wherein the processor is further configured to execute the set of instruction to cause the system to perform:
   determining the value of the first flag; and
   in response to a determination that the first flag is equal to zero, disabling the intra reference filtering.
25. The method of clause 18, further comprising:
   determining whether the bitstream includes the first flag; and
   in response to a determination that the bitstream does not include the first flag, disabling the PDPC.
26. The system of clause 18, further comprising:
   determining whether the bitstream includes the first flag; and
   in response to a determination that the bitstream does not include the first flag, enabling the PDPC.
27. The system of clause 18, further comprising:
   determining whether the bitstream includes the first flag; and
   in response to a determination that the bitstream does not include the first flag, disabling the intra reference filtering.
28. The system of clause 18, further comprising:
   determining whether the bitstream includes the first flag; and
   in response to a determination that the bitstream does not include the first flag, enabling the intra reference filtering.
29. The system of clause 18, wherein the processor is further configured to execute the set of instruction to cause the system to perform:
   determining a value of a second flag associated with a block differential pulse coded modulation (BDPCM);
   in response to the second flag having a first value, determining that the bitstream includes the first flag; and
   determining, based on a value of the first flag, whether the decoding process is disabled.
30. The system of clause 18, wherein the processor is further configured to execute the set of instruction to cause the system to perform:
   determining whether the bitstream is a 4:4:4 video bitstream;
   in response to the bitstream being the 4:4:4 video bitstream; and
   determining, based on a value of the first flag, whether the decoding process is disabled.
31. The system of clause 18, wherein the processor is further configured to execute the set of instruction to cause the system to perform:
   determining whether the bitstream is a 4:2:2 video bitstream;
   in response to the bitstream being the 4:2:2 video bitstream; and
   determining, based on a value of the first flag, whether the decoding process is disabled.
32. The system of clause 18, wherein the processor is further configured to execute the set of instruction to cause the system to perform:
   determining whether the bitstream is a 4:2:0 video bitstream;
   in response to the bitstream is not the 4:2:0 video bitstream; and
   determining, based on a value of the first flag, whether the decoding process is disabled.
33. The system of clause 18, wherein the processor is further configured to execute the set of instruction to cause the system to perform:
   determining a value of a third flag signaled in the bitstream; and
   in response to the third flag having a first value, disabling the decoding process, or
   in response to the second flag having a second value, determining, based on a value of the first flag, whether the decoding process is disabled.
34. The system of clause 33, wherein the third flag is a constraint flag.
35. A non-transitory computer readable medium that stores a set of instructions that is executable by one or more processors of an apparatus to cause the apparatus to initiate a method for decoding video data, the method comprising:
   receiving a video bitstream;
   determining whether a first flag associated with the bitstream satisfies a given condition; and
   in response to a determination that the first flag satisfies the given condition, disabling a decoding process for the bitstream, wherein the decoding process comprises at least one of position dependent intra prediction combination (PDPC) and intra reference filtering.
36. The non-transitory computer readable medium of clause 35, wherein the first flag is signaled in a sequence parameter set (SPS), a picture parameter set (PPS), a picture header (PH), or a slice header (SH).
37. The non-transitory computer readable medium of clause 35, wherein the given condition comprises the first flag having a value equal to one or zero.
38. The non-transitory computer readable medium of clause 37, wherein the set of instructions is executable by the at least one processor of the computer system to cause the computer system to further perform:
   determining the value of the first flag; and
   in response to a determination that the first flag is equal to one, disabling the PDPC.
39. The non-transitory computer readable medium of clause 37, wherein the set of instructions is executable by the at least one processor of the computer system to cause the computer system to further perform:
   determining the value of the first flag; and
   in response to a determination that the first flag is equal to zero, disabling the PDPC.
40. The non-transitory computer readable medium of clause 37, wherein the set of instructions is executable by the at least one processor of the computer system to cause the computer system to further perform:
   determining the value of the first flag; and
   in response to a determination that the first flag is equal to one, disabling the intra reference filtering.
41. The non-transitory computer readable medium of clause 37, wherein the set of instructions is executable by the at least one processor of the computer system to cause the computer system to further perform:
   determining the value of the first flag; and
   in response to the determination that the first flag is equal to zero, disabling the intra reference filtering.
42. The non-transitory computer readable medium of clause 35, wherein the set of instructions is executable by the at least one processor of the computer system to cause the computer system to further perform:
   determining whether the bitstream includes the first flag; and
   in response to a determination that the bitstream does not include the first flag, disabling the PDPC.
43. The non-transitory computer readable medium of clause 35, wherein the set of instructions is executable by the at least one processor of the computer system to cause the computer system to further perform:
   determining whether the bitstream includes the first flag; and
   in response to a determination that the bitstream does not include the first flag, enabling the PDPC.
44. The non-transitory computer readable medium of clause 35, wherein the set of instructions is executable by the at least one processor of the computer system to cause the computer system to further perform:
   determining whether the bitstream includes the first flag; and
   in response to a determination that the bitstream does not include the first flag, disabling the intra reference filtering.
45. The non-transitory computer readable medium of clause 35, wherein the set of instructions is executable by the at least one processor of the computer system to cause the computer system to further perform:
determining whether the bitstream includes the first flag; and
in response to a determination that the bitstream does not include the first flag, enabling the intra reference filtering.
46. The non-transitory computer readable medium of clause 35, wherein the set of instructions is executable by the at least one processor of the computer system to cause the computer system to further perform:
   determining a value of a second flag associated with a block differential pulse coded modulation (BDPCM);
   in response to the second flag having a first value, determining that the bitstream includes the first flag; and
   determining, based on a value of the first flag, whether the decoding process is disabled.
47. The non-transitory computer readable medium of clause 35, wherein the set of instructions is executable by the at least one processor of the computer system to cause the computer system to further perform:
   determining whether the bitstream is a 4:4:4 video bitstream; and
   in response to the bitstream being the 4:4:4 video bitstream, determining that the bitstream includes the first flag; and
   determining, based on a value of the first flag, whether the decoding process is disabled.
48. The non-transitory computer readable medium of clause 35, wherein the set of instructions is executable by the at least one processor of the computer system to cause the computer system to further perform:
determining whether the bitstream is a 4:2:2 video bitstream; and
in response to the bitstream being the 4:2:2 video bitstream, determining that the bitstream includes the first flag; and
determining, based on a value of the first flag, whether the decoding process is disabled.
49. The non-transitory computer readable medium of clause 35, wherein the set of instructions is executable by the at least one processor of the computer system to cause the computer system to further perform:
   determining whether the bitstream is a 4:2:0 video bitstream;
   in response to a determination that the video content is not the 4:2:0 video content, determining that the bitstream includes the first flag; and
   determining, based on a value of the first flag, whether the decoding process is disabled.
50. The non-transitory computer readable medium of clause 35, wherein the set of instructions is executable by the at least one processor of the computer system to cause the computer system to further perform:
   determining a value of a third flag signaled in the bitstream; and
   in response to the third flag having a first value, disabling the decoding process, or
   in response to the third flag having a second value, determining, based on a value of the first flag, whether the decoding process is disabled.
51. The non-transitory computer readable medium of clause 50, wherein the third flag is a constraint flag.
52. A computer-implemented video encoding method, comprising:
   determining whether a video bitstream satisfies a given condition; and
   in response to a determination that the bitstream satisfies the given condition, signaling, in the bitstream, a first flag indicating whether a coding process is disabled, wherein the coding process comprises at least one of position dependent intra prediction combination (PDPC) and intra reference filtering.
53. The method of clause 52, wherein the first flag is signaled in a sequence parameter set (SPS), a picture parameter set (PPS), a picture header (PH), or a slice header (SH).
54. The method of clause 52, wherein the first flag has a value equal to one or zero.
55. The method of clause 54, further comprising:
   determining whether the PDPC is disabled for the bitstream; and
   in response to a determination that the PDPC is disabled for the bitstream, setting the value of the first flag to be one.
56. The method of clause 54, further comprising:
   determining whether the PDPC is disabled for the bitstream; and
   in response to a determination that the PDPC is disabled for the bitstream, setting the value of the first flag to be zero.
57. The method of clause 54, further comprising:
   determining whether the intra reference filtering is disabled for the bitstream; and
   in response to a determination that the intra reference filtering is disabled for the bitstream, setting the value of the first flag to be one.
58. The method of claim 54, further comprising:
   determining whether the intra reference filtering is disabled for the bitstream; and
   in response to the determination that the intra reference filtering is disabled for the bitstream, setting the value of the first flag to be zero.
59. The method of clause 52, further comprising:
   determining whether the PDPC is disabled for the bitstream; and
   in response to a determination that the PDPC is disabled for the bitstream, not signaling the first flag to the bitstream.
60. The method of clause 52, further comprising:
   determining whether the PDPC is enabled for the bitstream; and
   in response to a determination that the PDPC is enabled for the bitstream, not signaling the first flag to the bitstream.
61. The method of clause 52, further comprising:
   determining whether the intra reference filtering is disabled for the bitstream; and
   in response to a determination that the intra reference filtering is disabled for the bitstream, not signaling the first flag to the bitstream.
62. The method of clause 52, further comprising:
   determining whether the intra reference filtering is enabled for the bitstream; and
   in response to a determination that the intra reference filtering is enabled for the bitstream, not signaling the first flag to the bitstream.
63. The method of clause 52, further comprising:
   determining whether a block differential pulse coded modulation (BDPCM) is disabled for the video content; and
   in response to a determination that the BDPCM is disabled, signaling the first flag in the bitstream,
   wherein the first flag is not signaled when the BDPCM is enabled for the bitstream.
64. The method of clause 52, further comprising:
   determining whether the bitstream is a 4:4:4 video bitstream; and
   in response to a determination that the bitstream is the 4:4:4 bitstream, signaling the first flag in the bitstream,
   wherein the first flag is not signaled when the bitstream is not the 4:4:4 video bitstream.
65. The method of clause 52, further comprising:
   determining whether the bitstream is a 4:2:2 video bitstream; and
   in response to a determination that the bitstream is the 4:2:2 video bitstream, signaling the first flag in the bitstream, wherein the first flag is not signaled when the video content is the 4:2:2 content.
66. The method of clause 52, further comprising:
   determining whether the bitstream is a 4:2:0 video bitstream; and
   in response to a determination that the video content is not the 4:2:0 video content, signaling the first flag in the bitstream, wherein the first flag is not signaled when the video content is the 4:2:0 content.
67. The method of clause 52, further comprising:
   determining a value of a second flag in the bitstream; and
   in response to a determination that the second flag has a first value, setting the first flag to a value indicating that the coding process is disabled.
68. The method of clause 67, wherein the second flag is a constraint flag.
69. A system for encoding video data, the system comprising:
   a memory storing a set of instructions; and
   a processor configured to execute the set of instructions to cause the system to perform:
      determining whether a video bitstream satisfies a given condition; and
      in response to a determination that the bit stream satisfies the given condition, signaling, in the bitstream, a first flag indicating whether a coding process is disabled, wherein the coding process comprises at least one of position dependent intra prediction combination (PDPC) and intra reference filtering.
70. The system of clause 69, wherein the first flag is signaled in a sequence parameter set (SPS), a picture parameter set (PPS), a picture header (PH), or a slice header (SH).
71. The system of clause 69, wherein the first flag has a value equal to one or zero.
72. The system of clause 71, wherein the processor is further configured to execute the set of instruction to cause the system to perform:
   determining whether the PDPC is disabled for the bitstream; and
   in response to a determination that the PDPC is disabled for the bitstream, setting the value of the first flag to be one.
73. The system of clause 71, wherein the processor is further configured to execute the set of instruction to cause the system to perform:
   determining whether the PDPC is disabled for the bitstream; and
   in response to a determination that the PDPC is disabled for the bitstream, setting the value of the first flag to be zero.
74. The system of clause 71, wherein the processor is further configured to execute the set of instruction to cause the system to perform:
   determining whether the intra reference filtering is disabled for the bitstream; and
   in response to a determination that the intra reference filtering is disabled for the bitstream, setting the value of the first flag to be one.
75. The system of clause 71, wherein the processor is further configured to execute the set of instruction to cause the system to perform:
   determining whether the intra reference filtering is disabled for the bitstream; and
   in response to the determination that the intra reference filtering is disabled for the bitstream, setting the value of the first flag to be zero.
76. The system of clause 69, wherein the processor is further configured to execute the set of instruction to cause the system to perform:
   determining whether the PDPC is disabled for the bitstream; and
   in response to a determination that the PDPC is disabled for the bitstream, not signaling the first flag to the bitstream.
77. The system of clause 69, wherein the processor is further configured to execute the set of instruction to cause the system to perform:
   determining whether the PDPC is enabled for the bitstream; and
   in response to a determination that the PDPC is enabled for the bitstream, not signaling the first flag to the bitstream.
78. The system of clause 69, wherein the processor is further configured to execute the set of instruction to cause the system to perform:
   determining whether the intra reference filtering is disabled for the bitstream; and
   in response to a determination that the intra reference filtering is disabled for the bitstream, not signaling the first flag to the bitstream.
79. The system of clause 69, wherein the processor is further configured to execute the set of instruction to cause the system to perform:
   determining whether the intra reference filtering is enabled for the bitstream; and
   in response to a determination that the intra reference filtering is enabled for the bitstream, not signaling the first flag to the bitstream.
80. The system of clause 69, wherein the processor is further configured to execute the set of instruction to cause the system to perform:
   determining whether a block differential pulse coded modulation (BDPCM) is disabled for the video content; and
   in response to a determination that the BDPCM is disabled, signaling the first flag in the bitstream, wherein the first flag is not signaled when the BDPCM is enabled for the bitstream.
81. The system of clause 69, wherein the processor is further configured to execute the set of instruction to cause the system to perform:
   determining whether the bitstream is a 4:4:4 video bitstream; and
   in response to a determination that the bitstream is the 4:4:4 video bitstream, signaling the first flag in the bitstream, wherein the first flag is not signaled when the video content is not the 4:4:4 video bitstream.
82. The system of clause 69, wherein the processor is further configured to execute the set of instruction to cause the system to perform:
   determining whether the bitstream is a 4:2:2 video bitstream; and
   in response to a determination that the bitstream is the 4:2:2 video bitstream, signaling the first flag in the bitstream, wherein the first flag is not signaled when the video content is the 4:2:2 video bitstream.
83. The system of clause 69, wherein the processor is further configured to execute the set of instruction to cause the system to perform:
   determining whether the bitstream is a 4:2:0 video bitstream; and
   in response to the determination that the bitstream is not the 4:2:0 video bitstream, signaling the first flag in the bitstream, wherein the first flag is not signaled when the video content is the 4:2:0 video bitstream.
84. The system of clause 69, wherein the processor is further configured to execute the set of instruction to cause the system to perform:
   determining a value of a second flag in the bitstream; and
   in response to a determination that the second flag has a first value, setting the first flag to a value indicating that the coding process is disabled.
85. The system of clause 84, wherein the second flag is a constraint flag.
86. A non-transitory computer readable medium that stores a set of instructions that is executable by one or more processors of an apparatus to cause the apparatus to initiate a method for video encoding, the method comprising:
   determining whether a video bitstream satisfies a given condition; and
   in response to a determination that the bitstream satisfies the given condition, signaling, in the bitstream, a first flag indicating whether a coding process is disabled, wherein the coding process comprises at least one of position dependent intra prediction combination (PDPC) and intra reference filtering.
87. The non-transitory computer readable medium of clause 86, wherein the first flag is signaled in a sequence parameter set (SPS), a picture parameter set (PPS), a picture header (PH), or a slice header (SH).
88. The non-transitory computer readable medium of clause 86, wherein the first flag has a value equal to one or zero.
89. The non-transitory computer readable medium of clause 88, wherein the set of instructions is executable by the at least one processor of the computer system to cause the computer system to further perform:
   determining whether the PDPC is disabled for the bitstream; and
   in response to a determination that the PDPC is disabled for the bitstream, setting the value of the first flag to be one.
90. The non-transitory computer readable medium of clause 88, wherein the set of instructions is executable by the at least one processor of the computer system to cause the computer system to further perform:
   determining whether the PDPC is disabled for the bitstream; and
   in response to a determination that the PDPC is disabled for the bitstream, setting the value of the first flag to be zero.
91. The non-transitory computer readable medium of clause 88, wherein the set of instructions is executable by the at least one processor of the computer system to cause the computer system to further perform:
   determining whether the intra reference filtering is disabled for the bitstream; and
   in response to the determination that the intra reference filtering is disabled for the bitstream, setting the value of the first flag to be one.
92. The non-transitory computer readable medium of clause 88, wherein the set of instructions is executable by the at least one processor of the computer system to cause the computer system to further perform:
   determining whether the intra reference filtering is disabled for the bitstream; and
   in response to the determination that the intra reference filtering is disabled, setting the value of the first flag to be zero.
93. The non-transitory computer readable medium of clause 86, wherein the set of instructions is executable by the at least one processor of the computer system to cause the computer system to further perform:
   determining whether the PDPC is disabled for the bitstream; and
   in response to a determination that the PDPC is disabled for the bitstream, not signaling the first flag to the bitstream.
94. The non-transitory computer readable medium of clause 86, wherein the set of instructions is executable by the at least one processor of the computer system to cause the computer system to further perform:
   determining whether the PDPC is enabled for the bitstream; and
   in response to a determination that the PDPC is enabled for the bitstream, not signaling the first flag to the bitstream.
95. The non-transitory computer readable medium of clause 86, wherein the set of instructions is executable by the at least one processor of the computer system to cause the computer system to further perform:
   determining whether the intra reference filtering is disabled for the bitstream; and
   in response to a determination that the intra reference filtering is disabled for the bitstream, not signaling the first flag to the bitstream.
96. The non-transitory computer readable medium of clause 86, wherein the set of instructions is executable by the at least one processor of the computer system to cause the computer system to further perform:
   determining whether the intra reference filtering is enabled for the bitstream; and
   in response to a determination that the intra reference filtering is enabled for the bitstream, not signaling the first flag to the bitstream.
97. The non-transitory computer readable medium of clause 86, wherein the set of instructions is executable by the at least one processor of the computer system to cause the computer system to further perform:
   determining whether a block differential pulse coded modulation (BDPCM) is disabled for the video content; and
   in response to a determination that the BDPCM is disabled, signaling the first flag in the bitstream, wherein the first flag is not signaled when the BDPCM is enabled for the bitstream.
98. The non-transitory computer readable medium of clause 86, wherein the set of instructions is executable by the at least one processor of the computer system to cause the computer system to further perform:
   determining whether the video bitstream is a 4:4:4 video bitstream; and
   in response to a determination that the video bitstream is a 4:4:4 video bitstream, signaling the first flag in the bitstream, wherein the first flag is not signaled when the video content is not the 4:4:4 video bitstream.
99. The non-transitory computer readable medium of clause 86, wherein the set of instructions is executable by the at least one processor of the computer system to cause the computer system to further perform:
   determining whether the bitstream is a 4:2:2 video bitstream; and
   in response to a determination that the video content is the 4:2:2 content, signaling the first flag in the bitstream, wherein the first flag is not signaled when the video is the 4:2:2 content.
100. The non-transitory computer readable medium of clause 86, wherein the set of instructions is executable by the at least one processor of the computer system to cause the computer system to further perform:
   determining whether the bitstream is a 4:2:0 video bitstream; and
   in response to the determination that the video content is not the 4:2:0 video content, signaling the first flag in the bitstream, wherein the first flag is not signaled when the video is the 4:2:0 video bitstream.
101. The non-transitory computer readable medium of clause 86, wherein the set of instructions is executable by the at least one processor of the computer system to cause the computer system to further perform:
   determining a value of a second flag in the bitstream; and
   in response to a determination that the second flag has a first value, setting the first flag to a value indicating that the coding process is disabled.
102. The non-transitory computer readable medium of clause 86, wherein the second flag is a constraint flag.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A computer-implemented video decoding method, comprising:
receiving a video bitstream;
determining whether a first flag associated with the bitstream satisfies a given condition; and
in response to a determination that the first flag satisfies the given condition, disabling a decoding process for the bitstream, wherein the decoding process comprises at least one of position dependent intra prediction combination (PDPC) and intra reference filtering.

2. The method of claim 1, wherein the first flag is signaled in a sequence parameter set (SPS), a picture parameter set (PPS), a picture header (PH), or a slice header (SH).

3. The method of claim 1, wherein the given condition comprises the first flag having a value equal to one or zero.

4. The method of claim 3, further comprising:
determining the value of the first flag; and
in response to a determination that the first flag is equal to one, disabling the PDPC.

5. The method of claim 3, further comprising:
determining the value of the first flag; and
in response to a determination that the first flag is equal to zero, disabling the PDPC.

6. The method of claim 3, further comprising:
determining the value of the first flag; and
in response to a determination that the first flag is equal to one, disabling the intra reference filtering.

7. The method of claim 1, further comprising:
determining whether the bitstream includes the first flag; and
in response to a determination that the bitstream does not include the first flag, enabling the intra reference filtering.

8. The method of claim 1, further comprising:
determining a value of a third flag signaled in the bitstream; and
in response to the third flag having a first value, disabling the decoding process, or
in response to the third flag having a second value, determining, based on a value of the first flag, whether the decoding process is disabled.

9. A system for decoding video data, the system comprising:
a memory storing a set of instructions; and
a processor configured to execute the set of instructions to cause the system to perform:
receiving a video bitstream;
determining whether a first flag associated with the bitstream satisfies a given condition; and
in response to the determination that the first flag satisfies the given condition, disabling a decoding process for the video content, wherein the decoding process comprises at least one of position dependent intra prediction combination (PDPC) and intra reference filtering.

10. The system of claim 9, wherein the first flag is signaled in a sequence parameter set (SPS), a picture parameter set (PPS), a picture header (PH), or a slice header (SH).

11. The system of claim 9, wherein the given condition comprises the first flag having a value equal to one or zero.

12. The system of claim 11, wherein the processor is further configured to execute the set of instruction to cause the system to perform:
determining the value of the first flag; and
in response to a determination that the first flag is equal to one, disabling the PDPC.

13. The system of claim 11, wherein the processor is further configured to execute the set of instruction to cause the system to perform:
determining the value of the first flag; and
in response to a determination that the first flag is equal to one, disabling the intra reference filtering.

14. The system of claim 9, further comprising:
determining whether the bitstream includes the first flag; and
in response to a determination that the bitstream does not include the first flag, enabling the intra reference filtering.

15. The system of claim 9, wherein the processor is further configured to execute the set of instruction to cause the system to perform:
determining a value of a third flag signaled in the bitstream; and
in response to the third flag having a first value, disabling the decoding process, or
in response to the second flag having a second value, determining, based on a value of the first flag, whether the decoding process is disabled.

16. A non-transitory computer readable medium that stores a set of instructions that is executable by one or more processors of an apparatus to cause the apparatus to initiate a method for decoding video data, the method comprising:
receiving a video bitstream;
determining whether a first flag associated with the bitstream satisfies a given condition; and
in response to a determination that the first flag satisfies the given condition, disabling a decoding process for the bitstream, wherein the decoding process comprises at least one of position dependent intra prediction combination (PDPC) and intra reference filtering.

17. The non-transitory computer readable medium of claim 16, wherein the first flag is signaled in a sequence parameter set (SPS), a picture parameter set (PPS), a picture header (PH), or a slice header (SH).

18. The non-transitory computer readable medium of claim 16, wherein the given condition comprises the first flag having a value equal to one or zero.

19. The non-transitory computer readable medium of claim 18, wherein the set of instructions is executable by the at least one processor of the computer system to cause the computer system to further perform:
determining the value of the first flag; and
in response to a determination that the first flag is equal to one, disabling the PDPC.

20. The non-transitory computer readable medium of claim 18, wherein the set of instructions is executable by the at least one processor of the computer system to cause the computer system to further perform:
determining the value of the first flag; and
in response to a determination that the first flag is equal to one, disabling the intra reference filtering.

21. The non-transitory computer readable medium of claim 16, wherein the set of instructions is executable by the at least one processor of the computer system to cause the computer system to further perform:
determining whether the bitstream includes the first flag; and
in response to a determination that the bitstream does not include the first flag, enabling the intra reference filtering.

22. The non-transitory computer readable medium of claim 16, wherein the set of instructions is executable by the at least one processor of the computer system to cause the computer system to further perform:
determining a value of a third flag signaled in the bitstream; and
in response to the third flag having a first value, disabling the decoding process, or
in response to the third flag having a second value, determining, based on a value of the first flag, whether the decoding process is disabled.
